(19) United States
(12) Patent Application Publication
(10) Pub. No.: US 2025/0153953 A1
(43) Pub. Date: May 15, 2025

(54) CLEATED CONVEYOR BELT CLEANER

(71) Applicant: Flexible Steel Lacing Company, Downers Grove, IL (US)

(72) Inventors: James Patrick McKee, Ada, MI (US); Ryan Matthew Rhodes, Grand Rapids, MI (US); Seth Wayne Adams, Rockford, MI (US)

(21) Appl. No.: 18/940,357

(22) Filed: Nov. 7, 2024

Related U.S. Application Data
(60) Provisional application No. 63/638,608, filed on Apr. 25, 2024.
(60) Provisional application No. 63/547,912, filed on Nov. 9, 2023.

(51) Int. Cl. B65G 45/16; B65G 15/44

(52) U.S. Cl. CPC B65G 45/16; B65G 15/44

(57) ABSTRACT

In one aspect, a cleated conveyor belt cleaner having a cleaning blade for engaging a conveyor belt, an elongate support for the cleaning blade, and mounts arranged to orient the elongate support to extend across the conveyor belt and allow the cleaning blade to engage with the conveyor belt and a cleat thereof. The mounts include a biasing member configured to apply a biasing force to keep the cleaning blade in biased engagement with the cleat as the cleat and a belt portion deflect by permitting the cleaning blade and elongate support to shift away from the belt portion against the bias force during the cleaning blade engagement with the cleat. The biasing member is configured to bias the elongate support back toward the belt portion and return the cleaning blade into engagement with the conveyor belt after the cleaning blade disengages from the cleat of the conveyor belt.

### CROSS-REFERENCE TO RELATED APPLICATIONS

This application claims the benefit of U.S. Provisional Application No. 63/547,912 filed Nov. 9, 2023, and U.S. Provisional Application No. 63/638,608 filed on Apr. 25, 2024, which are incorporated herein by reference in their entireties.

### FIELD

This disclosure relates to conveyor belt cleaners for removing material from a conveyor belt and, more specifically, relates to conveyor belt cleaners for cleated conveyor belts.

### BACKGROUND

Conveyors are used to convey objects from one location to another. Some conveyors utilize conveyor belts with a head pulley, a tail pulley, and one or more rollers supporting the conveyor belt. The conveyor has a drive, such as an electric motor, that rotates the head pulley to cause movement of the conveyor belt. An object is placed on an upper run of the conveyor belt and travels in a downstream direction as the head pulley rotates and causes movement of the conveyor belt. Conveyors may have a variety of configurations, including horizontal conveyors and conveyors having inclined segments.

Some facilities utilize conveyor belts that are inclined to transport conveyed objects, such as food items or products, from a lower position to a higher position. One example is a food processing facility that utilizes a conveyor belt system to transport meat, or other food items, from a lower position to a higher position. As one example, trimmed meat is transferred onto a conveyor belt of a conveyor belt system for movement across the facility. The conveyor belt system has a lower, upstream end and a higher, downstream end. The conveyor belt system conveys the meat toward the higher, downstream end of the conveyor belt system where the conveyed meat falls off of the conveyor belt and into a receptacle such as a cart. The higher downstream end of the conveyor belt system permits the cart to be positioned to receive the conveyed meat. Once the cart is full, a worker removes the cart and places a new cart under the end of the conveyor belt system to continue collecting conveyed meat.

Some inclined conveyor belts have cleats, sometimes referred to as flights, that support the conveyed food items as the conveyor belt advances the food items toward the higher, downstream end of the conveyor belt system. The cleats project outward from an outer surface of a belt portion of the conveyor belt to support the conveyed food items and keep the conveyed food items from rolling or sliding back upstream as the conveyed food items are conveyed downstream up the inclined conveyor belt.

The conveyed food items may fall off of the higher, downstream end of the conveyor belt system under the effect of gravity and into a receptacle or onto another conveyor belt. However, some of the conveyed food products may stick to the conveyor belt and cleats as the conveyor belt reverses direction around a downstream pulley of the conveyor belt system. The stuck food items may subsequently and undesirably fall from the conveyor belt onto the floor of the facility beneath the conveyor belt system and create waste which should be removed from the floor.

### SUMMARY

In one aspect of the present disclosure, a cleated conveyor belt cleaner is provided for cleaning a conveyor belt having a cleat projecting away from a belt portion of the conveyor belt. The cleated conveyor belt cleaner includes a cleaning blade for engaging the conveyor belt, an elongate support for the cleaning blade, and mounts arranged to orient the elongate support to extend across the conveyor belt and allow the cleaning blade to engage with the conveyor belt and the cleat thereof. The mounts include a biasing member configured to apply a biasing force to keep the cleaning blade in biased engagement with the cleat as the cleat and the belt portion deflect by permitting the cleaning blade and elongate support to shift away from the belt portion against the bias force during the cleaning blade engagement with the cleat. The biasing member is configured to bias the elongate support back toward the belt portion and return the cleaning blade into engagement with the conveyor belt after the cleaning blade disengages from the cleat of the conveyor belt. In this manner, the biasing member keeps the cleaning blade engaged with the cleat as the cleat deflects and returns the cleaning blade into engagement with the conveyor belt once the cleaning blade disengages from the cleat.

In one embodiment, cleaning blade has a belt engaging position wherein the cleaning blade engages the belt portion of the cleated conveyor belt upstream of the cleat and a clearance position wherein the cleaning blade has a spacing from the belt portion with the cleaning blade in biased engagement with the cleat, the spacing being sized to permit the cleat to travel downstream of the cleaning blade. The mounts are configured to permit the cleaning blade to be shifted by the cleat against the bias force from the biasing member from the engaging position to the clearance position. The engagement of the cleaning blade and the cleat as the cleat moves downstream causes the cleaning blade to travel along and clean the upstream surface of the cleat as well as shifts the cleaning blade from the belt engaging position to the clearance position so that the cleat can travel downstream past the cleaning blade.

The present disclosure also provides a cleated conveyor belt cleaner having a cleaning blade, an elongate support for the cleaning blade, and a pair of spring tensioners to be installed on opposite sides of the conveyor belt. The spring tensioners are configured to orient the elongate support to extend laterally along a support axis across the conveyor belt and permit pivoting of the elongate support about a pivot axis parallel to and longitudinally offset from the support axis in response to biased engagement of the cleaning blade with a cleat of the conveyor belt. The cleated conveyor belt cleaner further includes an opening extending longitudinally from the cleaning blade and elongate support to the pivot axis and laterally between the spring tensioners to provide space for an object removed from the conveyor belt to travel through the opening and away from the conveyor belt. The opening provides an enlarged area for a removed object, such as a piece of meat, to travel through without becoming caught on a rod or other structure of the cleated conveyor belt cleaner.

In another aspect of the present disclosure, a method is provided for cleaning a cleated conveyor belt having a belt portion and a cleat projecting therefrom. The method includes engaging a biased cleaning blade with a leading surface portion of the cleat to scrape the leading surface portion of the cleat. The method includes shifting the cleaning blade against a bias force applied thereto as the cleaning blade engages the leading surface portion of the cleat and causing the cleat and belt portion to deflect due to the biased engagement of the cleaning blade with the leading surface portion of the cleat at the same time as the cleaning blade is shifting. The method further includes re-engaging the cleaning blade with the belt portion of the cleated conveyor belt downstream of the cleat due to the bias force applied thereto after the leading surface portion of the cleat passes beyond the cleaning blade. The engagement of the cleaning blade and the cleat permits the cleaning blade to both clean the cleat and travel over the cleat during operation of the cleated conveyor belt.

The present disclosure also provides a cleaner blade for a cleated conveyor belt cleaner. The cleaner blade includes a single-piece body having opposite lateral sides and a length extending therebetween, an upper belt scraping portion of the body for engaging the conveyor belt, and a lower mounting portion configured to form a snap-fit connection with the elongate support. The lower mounting portion has a lower portion for extending below the elongate support and a front portion of the lower mounting portion extending upward from the lower portion toward the upper belt scraping portion. The front portion is configured to be positioned in front of the elongate support with the lower mounting portion connected with the elongate support. The lower mounting portion includes a plurality of rear gripping portions extending upward from the lower portion spaced rearward of the front portion to permit the elongate support to be received between the front portion and the rear gripping portions. The lower mounting portion further includes at least one spacing between the rear gripping portions that extends along the length of the body and facilitates deflection of the rear gripping portions as the lower mounting portion is connected with the elongate support. The at least one spacing between the rear gripping portions increases the flexibility of the gripping portions and enables an installer to readily connect the cleaning blade to the elongate support or disconnect the cleaning blade from the elongate support.

In another aspect, a conveyor belt system is provided that includes a cleated conveyor belt cleaner and a cleated conveyor belt having a belt portion and a cleat projecting from the belt portion. The cleated conveyor belt cleaner includes a cleaning blade for engaging the cleated conveyor belt, an elongate support for the cleaning blade, and mounts to orient the elongate support to extend across the cleated conveyor belt and allow the cleaning blade to engage the cleated conveyor belt. The mounts are configured to permit the cleaning blade to be shifted away from the belt portion by engagement between the cleaning blade and the cleat. The mounts include a biasing member of configured to bias the cleaning blade back toward the belt portion and return the cleaning blade into engagement with the belt portion of the cleated conveyor belt after the cleaning blade disengages from the cleat of the conveyor belt. The mounts thereby permit the cleaning blade to shift out of the path of the cleat as the cleaning blade cleans the cleat and re-engages the cleaning blade with the cleated conveyor belt once the cleat has traveled past the cleaning blade.

### BRIEF DESCRIPTION OF THE DRAWINGS

FIG. 1 is a perspective view of a conveyor system including a cleated conveyor belt and a cleated conveyor belt cleaner;

FIG. 2 is a cross-sectional view taken across line 2-2 in FIG. 1 showing a cleaning blade of the cleated conveyor belt cleaner engaged with an outer surface of the cleated conveyor belt;

FIG. 3 is a front elevational view of one of the resilient mounts of the cleated conveyor belt cleaner of FIG. 1 showing a torsion spring of the resilient mount that urges the cleaning blade into engagement with the conveyor belt;

FIG. 4 is a cross-sectional view taken across line 4-4 in FIG. 3 showing an arm of the resilient mount having one end connected to a shaft of the resilient mount and another end connected to an angle bar that extends laterally across the conveyor belt and supports the cleaning blade;

FIG. 5 is a side elevational view of the cleated conveyor belt cleaner of FIG. 3 showing a lobe-shaped mounting plate of the cleated conveyor belt cleaner extending radially from a head pulley of the conveyor system;

FIG. 6 is a cross-sectional view taken across line 6-6 in FIG. 5 showing a large, laterally extending opening between the resilient mounts of the cleated conveyor belt cleaner downstream from the cleaning blade that permits objects removed from the conveyor belt by the cleaner to travel through the opening and between the resilient mounts without becoming caught on the cleaner;

FIG. 7 is an enlarged view of the area in the dashed circle of FIG. 6 showing the arm interconnecting the angle bar and the shaft of the resilient mount;

FIG. 8 is a cross-sectional view of the cleaning blade of FIG. 2 showing a concave surface portion of the cleaning blade that forms a recess to receive a free end of the cleat as the cleaning blade scrapes the conveyor belt;

FIG. 9 is an enlarged view of the area shown in the dashed circle in FIG. 8 showing a distal, end surface portion surface of the cleaning blade that engages the cleated conveyor belt;

FIG. 10 is a perspective view of the cleated conveyor belt cleaner of FIG. 1 removed from the cleated conveyor belt and showing optional covers for covering the movable components of the resilient mounts;

FIGS. 11-16 are perspective views of the cleated conveyor belt cleaner of FIG. 10 used in another conveyor belt system and showing: the cleaning blade engaging an outer surface of the conveyor belt; being deflected as the cleaning blade engages, cleans and deflects one of the cleats; and returns into engagement with the outer surface of the conveyor belt after the cleat has traveled beyond the cleaning blade;

FIGS. 17-20 are perspective views of one of the resilient mounts of the cleated belt cleaner of FIGS. 11-16 which sequentially show the angle bar pivoting in a first rotary direction away from the conveyor belt to permit the cleaning blade to travel over the cleat (FIGS. 17 and 18) and the torsion spring returning the angle bar and cleaning blade thereon in an opposite rotary direction back into engagement with the outer surface of the conveyor belt (FIGS. 19 and 20);

FIGS. 21-27 are perspective views of an underside of the conveyor belt system of FIGS. 11-16 showing the cleaning blade scraping an outer surface of the conveyor belt (FIGS. 21 and 22), scraping a leading surface of the cleat (FIGS. 23 and 24), disengaging from the cleat (FIG. 25), and snapping back into engagement with the outer surface of the conveyor belt (FIGS. 26 and 27);

FIG. 28 is a perspective view of the cleated conveyor belt cleaner of FIG. 11 with a bumper to dampen movement of the cleaning blade as the cleaning blade pivots back into engagement with the belt portion of the cleated conveyor belt;

FIG. 29 is a perspective view of the cleated conveyor belt cleaner of FIG. 10 with an adjustable bumper to dampen movement of the cleaning blade as the cleaning blade pivots back into engagement with the belt portion of the cleated conveyor belt;

FIG. 30 is a plan view of a pneumatic dampener for the cleated conveyor belt cleaner of FIG. 10 to slow the movement of the cleaning blade as the cleaning blade pivots back into engagement with the belt portion of the cleated conveyor belt;

FIG. 31 is a perspective view of a wrap spring brake for dampening rotation of the shaft of one of the tensioners of the cleated conveyor belt cleaner of FIG. 10;

FIGS. 32-38 are schematic views of the wrap spring brake of FIG. 31 showing the operation of the wrap spring brake as the scraper blade is shifted away from the belt portion of the conveyor belt by a cleat and the scraper blade returns back into engagement with the belt portion;

FIG. 39 is a perspective view of another resilient mount that may be utilized with the cleated conveyor belt cleaner of FIG. 1;

FIG. 40 is a cross-sectional view taken along line 40-40 in FIG. 39 showing a torsion spring of the resilient mount that constricts and tightly engages a tensioning hub and a split collar of the resilient mount upon tensioning of the spring;

FIG. 41 is a perspective view of the tensioning hub of FIG. 40 showing a boss of the tensioning hub sized to fit into a first end portion of the torsion spring;

FIG. 42 is a perspective view of the collar of FIG. 40 showing a boss of the split collar sized to fit into a second end portion of the torsion spring;

FIG. 43 is a plan view of another torsion spring that may be utilized with the resilient mount of FIG. 39 showing ends of the spring having axial protrusions to engage corresponding recesses of the tensioning hub and collar;

FIG. 44 is a perspective view of one of the ends of the spring of FIG. 43 showing one of the protrusions protruding axially from an end coil of the spring;

FIG. 45 is a perspective view of an end of the spring of FIG. 43 showing the axial protrusion of the end of the spring extending into a slot of the split collar of the resilient mount of FIG. 39;

FIG. 46 is a perspective view of an end of another torsion spring having a radial protrusion to engage a recess in either the tensioning hub or the collar;

FIG. 47 is a perspective view of an end of another torsion spring having a radial protrusion to engage a recess in either the tensioning hub or the collar;

FIG. 48 is a rear perspective view of a cleated conveyor belt cleaner having resilient mounts with brackets that depend from bearings of a head pulley of a conveyor belt system;

FIG. 49 is a front elevational view of the cleated conveyor belt cleaner of FIG. 48 showing retainers of an angle bar of the cleated conveyor belt cleaner on either side of the cleaning blade to inhibit movement of the cleaning blade along the angle bar during operation of the cleated conveyor belt cleaner;

FIG. 50 is a rear perspective view of the cleaning blade of FIG. 49 showing a pair of rear gripping portions of the cleaning blade having a spacing therebetween;

FIG. 51 is a side elevational view of the cleaning blade of FIG. 50 showing a recess of the cleaning blade that receives the angle bar;

FIG. 52 is a perspective view of another cleaning blade having three gripping portions and two spacings therebetween; and

FIG. 53 is a perspective view of a cleated conveyor belt cleaner having resilient mounts including mounting plates with laterally inwardly extending flanges to be installed between pillow block bearings and a conveyor frame of a conveyor system.

### DETAILED DESCRIPTION

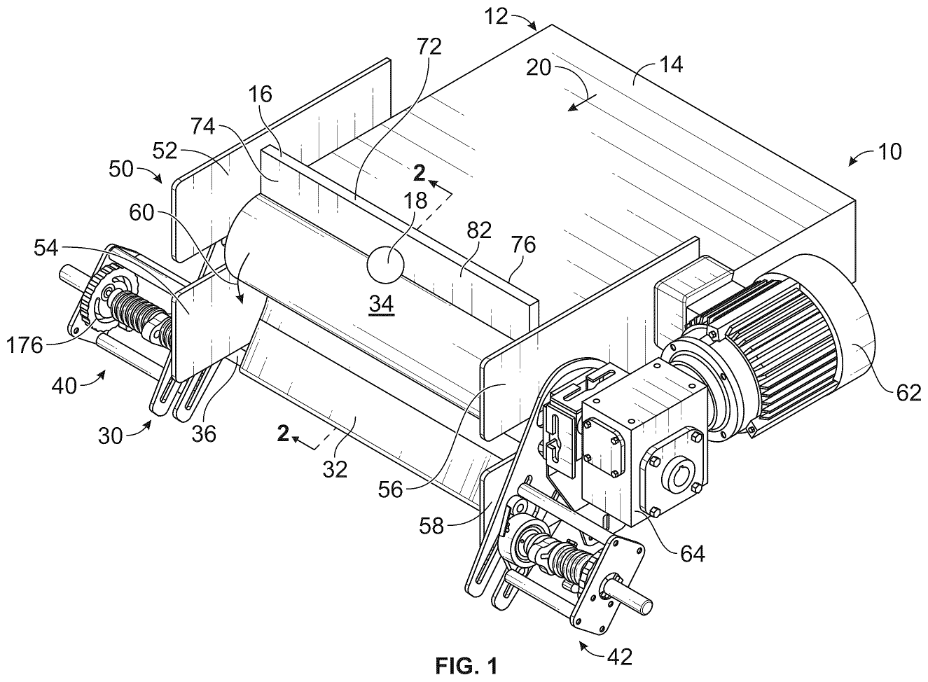

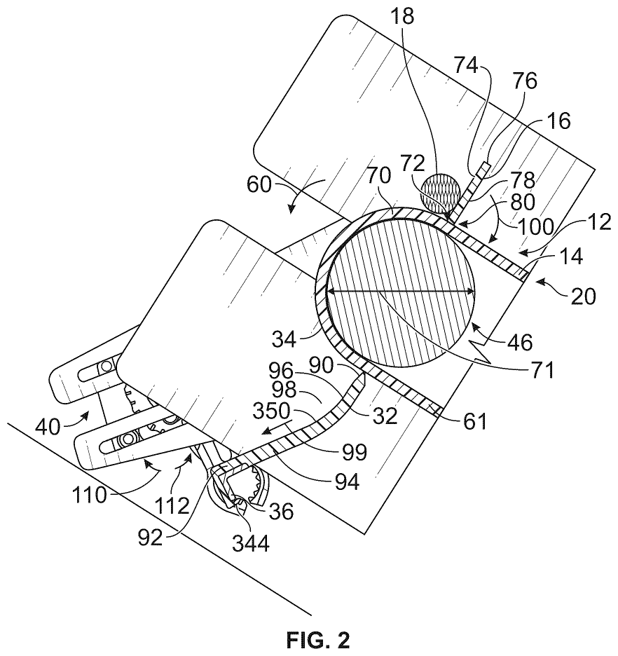

With regard to FIG. 1, a conveyor system 10 is shown that includes a cleated conveyor belt 12 having belt segments or portions 14 with associated cleats 16 for conveying an object 18 in a downstream, longitudinal direction 20. The conveyor system 10 includes a cleated conveyor belt cleaner 30 with a cleaning blade 32 positioned to scrape an outer surface 34 of the belt 12 and a leading surface 74 of the cleat 16 to remove the object 18 from the cleated conveyor belt 12 and the leading surfaces 74 of the cleats 16 thereof. The cleaning blade 32 is connected to an elongate support or mounting member, such as an angle bar 36, that extends laterally across the cleated conveyor belt 12. The cleated conveyor belt cleaner 30 has resilient mounts 40, 42 that support the angle bar 36 and cleaning blade 32 thereon. The resilient mounts 40, 42 are configured to firmly engage the cleaning blade 32 with the cleated conveyor belt 12 while, at the same time, permitting the cleaning blade 32 to be deflected and pivot out of the way of the cleat 16 such as when the cleat 16 travels around a head pulley 46 (see FIG. 2) of the conveyor system 10.

The conveyor system 10 includes a conveyor frame 50 to support the cleated conveyor belt 12 and the cleated conveyor belt cleaner 30. The conveyor frame 50 may include upper skirt wall 52, 54, and lower skirt walls 56, 58 with the upper skirt walls 52, 54 operable to keep the conveyed object 18 on the belt 12 as the conveyed object 18 travels in the downstream direction 20. The conveyor system 10 further includes a drive for effecting movement of the cleated conveyor belt 12, such as a motor 62 and a gearbox 64 connecting the motor 62 to the head pulley 64. The motor 62 is operable to cause rotation of the head pulley 46 which, in turn, drives the cleated conveyor belt 12 in the downstream direction 20.

As can be seen in FIG. 2, the cleat 16 protrudes or is upstanding from the outer surface 34 of the belt 14 to generally extend normal therefrom. The cleated conveyor belt 12 is inclined and the cleat 16 can support the object 18 to keep the object 18 from sliding or rolling upstream and downwardly away from the head pulley 46. The cleat 16 and object 18 travel around the head pulley 46 generally in rotary direction 60 until the object 18 falls off of the cleated conveyor belt 12 under the effect of gravity. The outer surface 34 of the cleated conveyor belt 12 follows the curvature of the head pulley 46 to have a curved portion 70 as the cleated conveyor belt 12 travels around the head pulley 46. The object 18 may fall off of the curved portion 70 of the belt outer surface 34 when the object 18 reaches a position near or below an equator or horizontal centerline 71 of the head roller 46. The object 18 may fall into a receptacle or onto another conveyor belt, as some examples.

The cleat 16 has a tapered or flared out leading surface portion 72 of base portion 82 of the cleat 16, a leading surface 74 extending upwardly from the surface portion 72, a free end 76, a trailing surface 78 parallel to the leading surface 74, and a tapered or flared out trailing surface portion 80 of the base portion 82 (see FIG. 1) of the cleat 16. In some cleated conveyor belts, the cleats may not have bases with tapered leading and trailing surface portions.

The cleaning blade 32 has an upper scraping tip 90 configured for being engaged with the outer surface 34 of the belt 14, a lower mounting base portion 92 configured for being secured to the angle bar 36, and an intermediate portion 94 extending therebetween. The cleaning blade 32 has a concave upstream surface portion 96 of the blade intermediate portion 84 configured to form a recess 98. The recess 98 provides clearance for the free end 76 of the cleat 16 to extend therein as the cleaning blade 32 engages the junction between the conveyor of belt outer surface 34 and the flared out leading surface portion 72 of the cleat 16, as discussed further hereafter.

With reference to FIG. 2, the object 18 may stick or adhere to the cleated conveyor belt 12 and travel with the cleated conveyor belt 12 below the centerline 71 of the head pulley 46 toward a return run 61 of the cleated conveyor belt 12. For example, the object 18 may include one or more pieces of meat, baked goods, corn, peas, fasteners (e.g. bolts or screws), ball bearings, or other items.

To ensure the object 18 is removed from the cleated conveyor belt 12 rather than traveling on the return run 61, the cleated conveyor belt cleaner 30 positions the scraping tip 90 to scrape the outer surface 34 of the belt portion 14 below the centerline 71 of the head pulley 46. If the object 18 is scraped off of the outer surface 34 by the cleaning blade 32, the object can slide in direction 99 down along an upstream surface 350 of the cleaning blade 32 and into an awaiting receptacle or downstream conveyor belt therebelow. The cleaning blade 32 thereby operates to remove the object 18 from the cleated conveyor belt 12 as well as direct the object 18 to a desired location after removing the object 18.

With continued reference to FIG. 2, the scraping tip 90 scrapes the outer surface 34 of the belt portion 14 of the cleated conveyor belt 12 as the cleated conveyor belt 12 moves in the downstream direction 20 until the scraping tip 90 encounters the tapered leading surface portion 72 of the cleat 16. Notably, the concave side surface portion 96 of the blade 32 provide the cleat 16 clearance to extend into the recess 98 to allow the scraping tip 90 to engage and clean the tapered surface portion 72 of the cleat 16 without interference from the cleat 16 itself. The tapered leading surface portion 72 provides a smooth transition between the outer surface 34 of the belt portion 14 and the leading surface 74 of the cleat 16.

Continued movement of the cleated conveyor belt 12 in the downstream direction 20 causes the scraping tip 90 to tightly engage and scrape the leading surface 74 of the cleat 16. The engagement of the scraping tip 90 with the leading surface 74 deflects the cleat 16 in trailing direction 100 as the conveyor belt 12 moves downstream of the head pulley 46 and simultaneously causes the cleaning blade 32 and angle bar 36 to pivot in direction 110. In one form, the cleat 16 has a unitary, one-piece construction with the belt portion 14 and may be formed by molding the cleated conveyor belt 12 and belt portion 14 from a food-grade plastic material. The cleat 16 and/or the belt portion 14 are resilient to also permit the cleat 16 to resiliently deflect or pivot in direction 100 relative to the belt portion 14 as the cleat 16 travels beneath the cleaning blade 32.

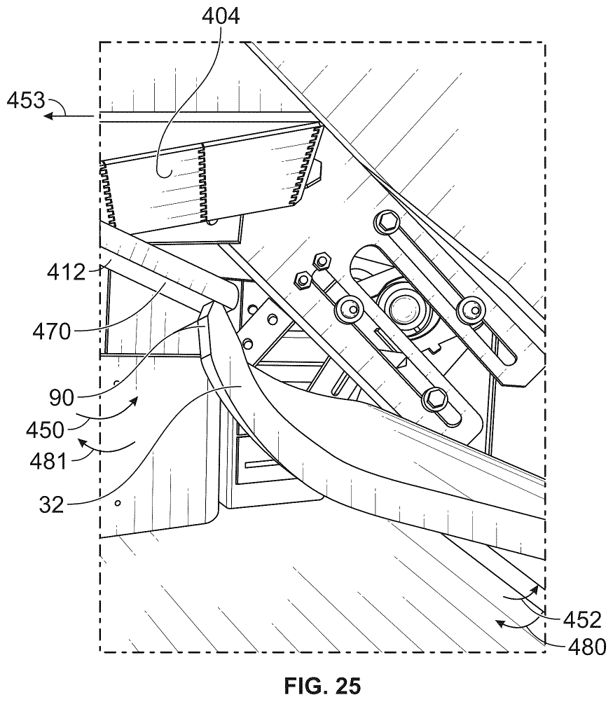

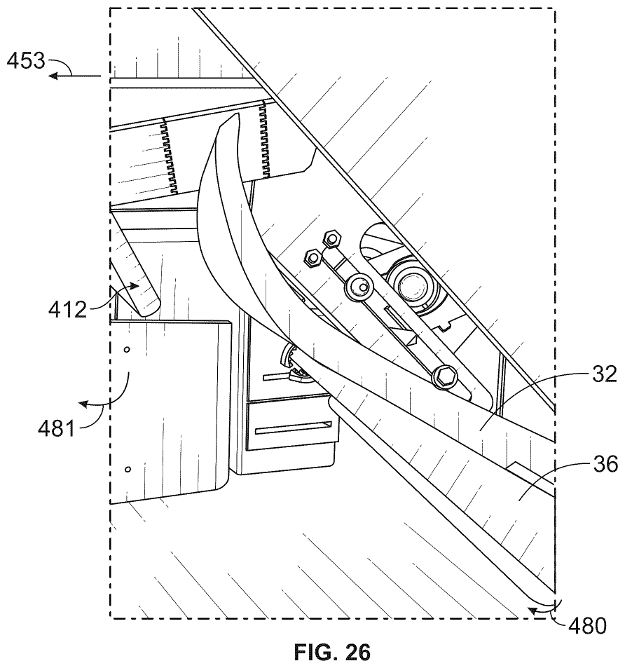

Continued movement of the cleated conveyor belt 12 in the downstream direction 20 causes the scraping tip 90 to travel past and off of the free end 76 of the cleat 16 to disengage from the cleat 16 (see e.g., FIGS. 25-26). With the cleaning blade 32 no longer displaced by the cleat 16, the resilient mounts 40, 42 resiliently urge the angle bar 36 and the cleaning blade 32 mounted thereto back in rotary direction 112 to return the scraping tip 90 into engagement with the cleated conveyor belt 12. In this manner, the cleaning blade 32 may deflect the cleat 16 with shifting of the conveyor belt 12 to permit the cleat 16 to travel past the cleaner blade 32 without damaging the cleat 16.

The resilient mounts 40, 42 snap the scraping tip 90 back into engagement with the cleated conveyor belt 12, although one or more objects on or adhered to the upstream surface 350 of the cleaning blade 32, such as scraped-off pieces of meat, may reduce the return force with which the cleaning blade 32 is urged back into engagement with the belt 12. By reducing the return velocity of the cleaning blade 32, the one or more objects on the upstream surface 350 also reduces the impact force the scraping tip 90 imparts to the belt portion 14 as the scraping tip 90 re-engages the cleated conveyor belt 12.

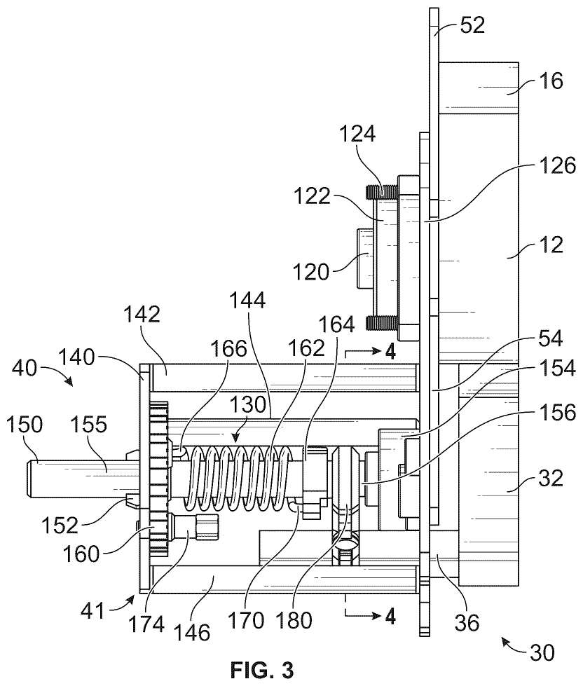

Referencing FIG. 3, only the resilient mount 40 will be discussed although the resilient mount 42 is generally a mirror image thereof. The resilient mount 40 has an arm 180 supporting the angle bar 36 and cleaning blade 32 to be cantilevered off of the shaft 150. The resilient mount 40 has a tensioner 130 that applies a resilient biasing force to the angle bar 36 and cleaning blade 32 mounted thereon to urge the cleaning blade 32 into engagement with the cleated conveyor belt 12. The tensioner 130 is adjustable to cause the cleaning blade 32 to engage the belt portion 14 of the cleated conveyor belt 12 with a desired amount of force.

The resilient mount 40 has a laterally outer frame assembly 41 including a side plate 140 interconnected to a bracket of the resilient mount 40, such as an elongated, lobe-shaped, laterally inner mounting plate 126, via support members in the form of support rods 142, 144, 146. In one embodiment, two of the three support rods 142, 144, 146 are used. The resilient mount 40 includes the shaft 150 having an end portion 155 rotatably supported in an opening of the side plate 40 via a shaft bushing 152. Further, the resilient mount 40 has a bearing 154 adjacent the mounting plate 126 rotatably supporting an opposite end portion 156 of the shaft 150.

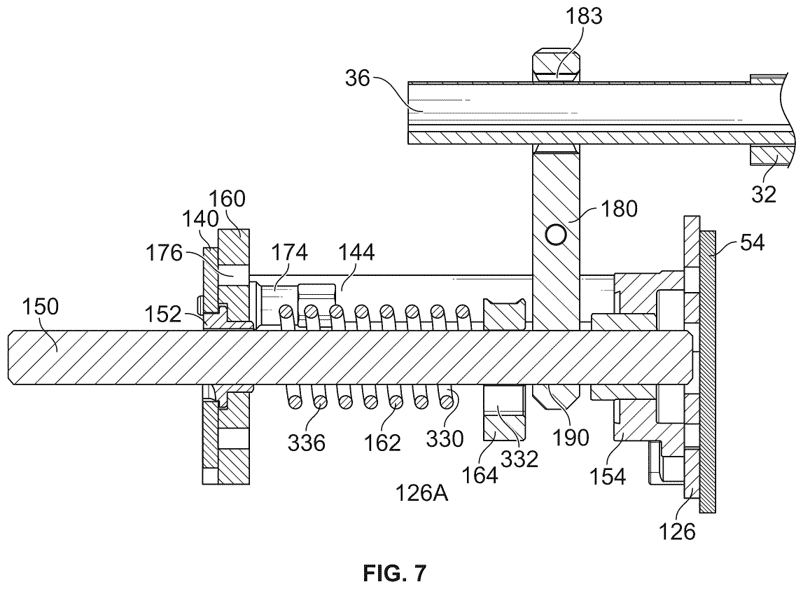

The tensioner 130 includes a tensioning disc or hub 160, a biasing member such as a torsion spring 162, and a collar 164. The torsion spring 162 has an end 166 secured to the tensioning hub 160 and an opposite end 170 secured to the collar 164 with spring coils 336 (see FIG. 7) arranged between the spring ends 166, 170. The ends 166, 170 of the torsion spring 162 are secured and fixed to the respective tensioning hub 160 and collar 164 via welds, interlocking portions, or fasteners as some examples. The collar 164 and arm 180 are fixed to the shaft 150 such as via clamping engagements, mating portions, welds, brazing, and/or fasteners. Due to the fixed connections between the collar 164, arm 180, and shaft 150, turning of the shaft 150 causes turning of the collar 164 and arm 180. By contrast, the tensioning hub 160 can turn or rotate relative to the shaft 150.

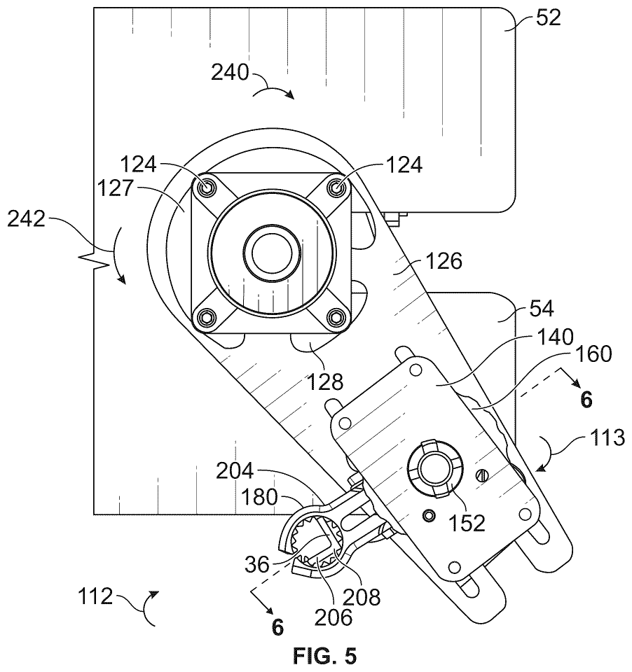

The tensioner 130 further includes a set bolt 174 that extends through an arcuate slot 176 (see FIGS. 1, 7) of the tensioning hub 160 and into an aligned, threaded opening of the side plate 140 for fixing the tensioning hub 160 against turning relative to the side plate 140. More specifically, during installation of the cleated conveyor belt cleaner 30, a user loosens the set bolt 174 and turns the tensioning hub 160 in rotary direction 113 (see FIG. 5) to bring the cleaning blade 32 into contact with the belt portion 14 of the cleated conveyor belt 12. Turning the tensioning hub 160 in rotary direction 113 causes the shaft 150 to turn in corresponding rotary direction 112 via the connections between the tensioning hub 160, torsion spring 162, collar 164 and shaft 150 as discussed above. Turning the shaft 150 in direction 112 pivots the arm 180 secured to the shaft 150 in direction 112, which brings the cleaning blade 32 into contact with the belt portion 14 of the cleated conveyor belt 12.

Once the scraping tip 90 contacts the belt portion 40, the user continues turning the tensioning hub 160 in direction 113 (see FIG. 5) to apply a desired force to the cleaning blade 32. More specifically, turning the tensioning hub 160 farther in direction 113 once the cleaning blade 32 contacts the belt portion 14 of the cleated conveyor belt 12 causes the tensioning hub 160 to turn relative to the collar 164 and loads the torsion spring 162 by tensioning the torsion spring 162. The torsion spring 162 resists the loading and applies a torque on the shaft 150 via the collar 164 fixed thereto. The torque applied to the shaft 150 urges the arm 180 and angle bar 36 in direction 112 which applies a force to the cleaning blade 32. Once the user has applied a desired force to the cleaning blade 32, the user tightens down the set bolt 174 to fix the tensioning hub 160 against rotation relative to the side plate 140.

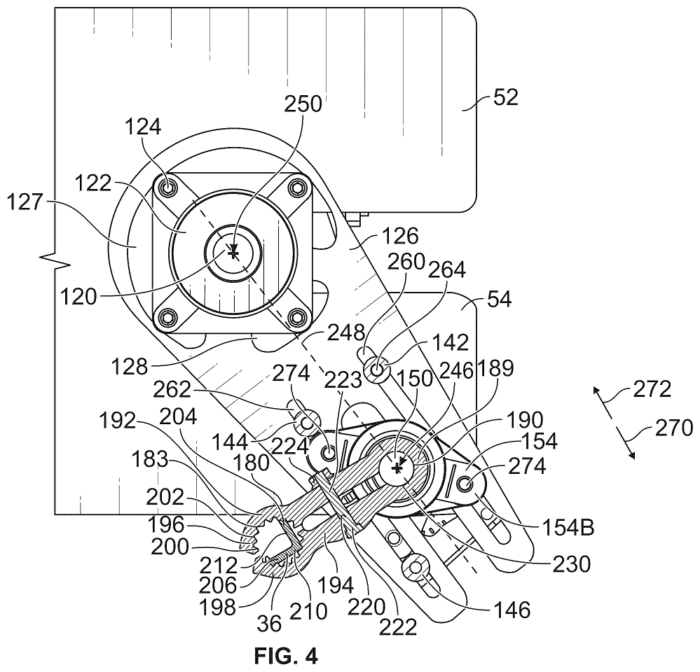

With reference to FIG. 3, the head pulley 46 has a shaft 120 rotatably mounted to the skirt wall 52 via a bearing 122. The bearing 122 is secured to the skirt walls 52 via fasteners 124 that extend through arcuate, upper and lower slots 127, 128 (see FIG. 4) of the mounting plate 126. In this manner, the mounting plate 126 is sandwiched between the bearing 122 and the skirt wall 52. In other embodiments, the mounting plate 126 may be mounted to different conveyor frame elements, such as in situations where the bearings of a head pulley of a conveyor belt are not removable.

Turning to FIG. 4, the arm 180 has an arcuate end portion 189 with an opening 190 that receives the shaft 150 and a pair of arm portions 192, 194 extending from the arcuate end portion 189. The opening 190 and shaft 150 are sized so that the arm 180 can be pivoted about the shaft 150 during installation and before the arm 180 is fixed to the shaft 150.

The arm portions 192, 194 have end clamping portions 196, 198 that define an opening 183 therebetween for receiving the angle bar 36. The clamping portions 196, 198 are configured to clamp onto and fix the angle bar 36 against movement relative to the arm 180. The clamping portions 196, 198 include alternating teeth 200 and recesses 202 for receiving and engaging ends 204, 206 and a corner 208 (see FIG. 5) of the angle bar 36. The angle bar 36 has two legs 210, 212 oriented at approximately 90° relative to one another. In other forms, the legs 210, 212 may have a different relative angular orientation or the angle bar 36 may be replaced with a pole or a bar having a rectangular cross-section as some examples.

The alternating teeth 200 and recesses 202 of the clamping portions 196, 198 permit the angle bar 36 to be advanced into the opening 183 and clamped in position at any one of a plurality of angular orientations of the angle bar 36 relative to the arm 180. The plurality of angular mounting orientations of the angle bar 36 and the pivoting of the arm 180 permits the cleated conveyor belt cleaner 30 to be installed to conveyor belt systems having different conveyor frame configurations and dimensions.

The arm 180 has a bolt 220 with a head 222 non-rotatably received in a recess of the arm portion 194 and a threaded shank 223 engaged with a nut 224 positioned against the arm portion 192. To fix the arm 180 against pivoting on the shaft 150 and to fix the angle bar 36 against movement relative to the arm 180, a user turns the nut 224 to advance the nut 224 toward the bolt head 222 and urge the arm portions 192, 194 together which shifts the clamping portions 196, 198 to tightly clamp onto the angle bar 36. Further, urging the arm portions 192, 194 together by tightening down of the nut 224 also decreases the size of the opening 190 so that an arcuate inner surface 230 of the arcuate portion 199 extending about the opening 190 tightly engages a cylindrical outer surface of the shaft 150 to fix the arm 180 against pivoting relative to the shaft 150. In one approach, a weld or brazing is used to further secure the arm 180 to the shaft 150. The weld or brazing may be applied during installation or manufacture of the cleated conveyor belt cleaner 30.

Regarding FIGS. 4 and 5, the slots 127, 128 of the mounting plate 126 are elongated and permit the mounting plate 126 to be turned in opposite rotary directions 240, 242 to orient an axis 248 of the mounting plate 126 at a desired angle relative to the axis of the head pulley 46 prior to fully fixing the bearing 122 to the skirt walls 52, 54. The slots 127, 128 of the mounting plate 126 thereby enable the cleated conveyor belt cleaner 30 to be installed on conveyor belt systems have different configurations and dimensions. In one installation technique, the fasteners 124 are loosened to permit the mounting plate 126 to be turned in directions 240, 242 while the fasteners 124 extend in the slots 127, 128. Additionally, the mounting plate 126 operatively mounts the shaft 150 thereto with a central pivot axis 246 of the shaft 150 aligned with the axis 248 of the mounting plate 126. The axis 248 extends radially from a central rotational axis 250 of the shaft 120 of the head pulley 46 to the pivot axis 246 of the shaft 150. Because the arm 180 and angle bar 36 can turn with the shaft 150, the pivot axis 246 of the shaft 150 operates as the pivot axis of the resilient mount 40 with the angle bar 36 and cleaning blade 32 thereon pivoting about the pivot axis 246 during operation of the conveyor system 10. It will be appreciated that different configurations of the mounting plates 126 may be used for different conveyors having different installation constraints.

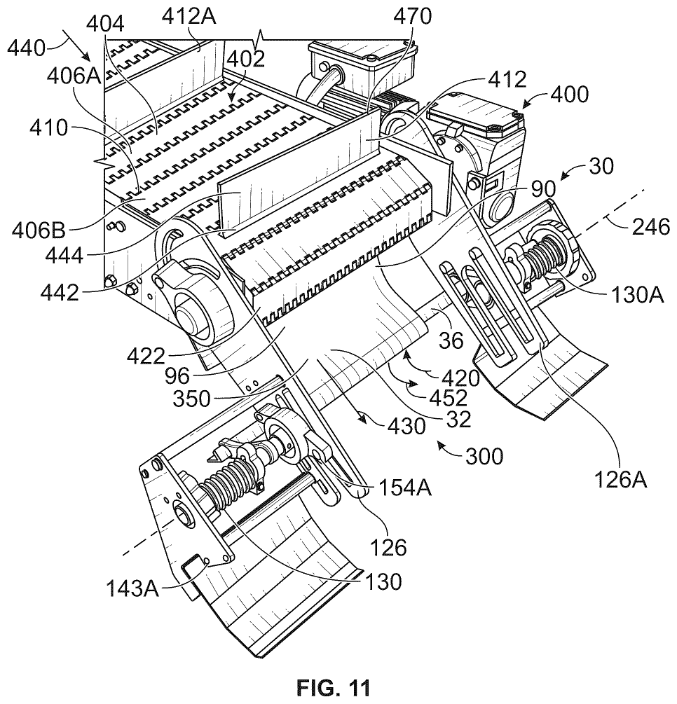

To provide additional adjustability during installation, the mounting plate 126 has a pair of parallel, linearly extending slots 260, 262 (see FIG. 4) and the support rods 142, 144, 146 are cylindrical members with threaded bores 264 at opposite ends of the support rods 142, 144, 146 to receive bolts 143A (see FIG. 11). The bolts at the laterally inner ends of the support rods 142, 144, 146 extend therefrom and through the slots 260, 262 for securing the support rods 142, 144, 146 to the mounting plate 126 and from a laterally outer end of the support rods 142, 144, 146 for being secured to the side plate 140. The support rods 142, 144, 146 may include wrenching flats for engaging with a wrench during installation of the cleated conveyor belt cleaner 30.

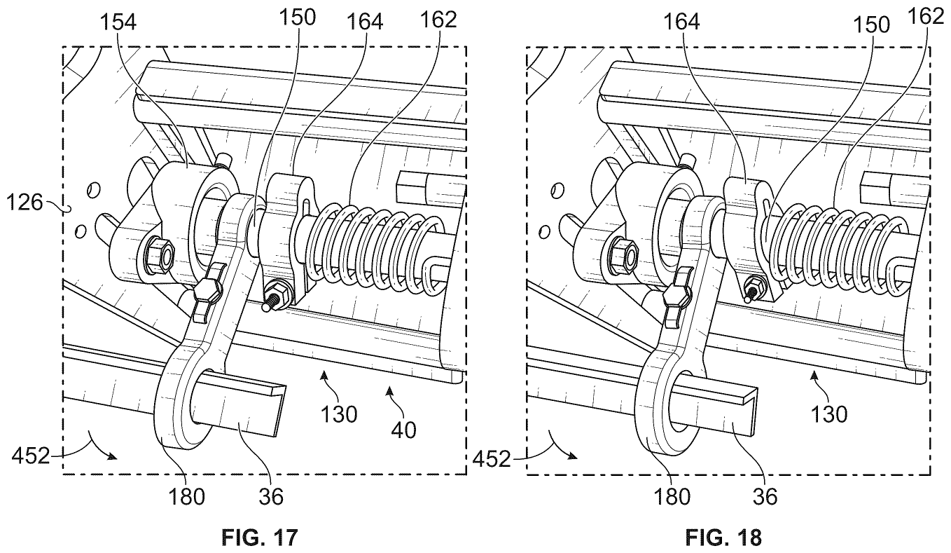

The bearing 154 is secured to the mounting plate 126 with fasteners such as bolts 154A (see FIG. 11) that extend in through openings 274 of flanges 154B of the bearing 154 into the slots 260, 262 with nuts (see FIG. 17) threaded onto ends of the bolts. The bolts of the support rods 142, 144, 146 and the fasteners of the bearing 154 are not shown in FIGS. 1-5 to provide a less obstructed view of the components of the cleated belt cleaner 30. The bolts are shown, however, in FIGS. 11-20.

Regarding FIG. 4, prior to tightening down the bolts 143A of the support rods 142, 144, 146 and the bolts 154A of the bearing 154 of the resilient mounts 40, 42, the resilient mounts 40, 42 may be shifted in either of opposite linear or radial directions 270, 272 along the axis 248 to position the pivot axis 246 of the resilient supports 40, 42 at a desired radial distance from the rotational axis 250 of the head pulley 46. The bolts 143A of the support rods 142, 144, 146 and the bolts 154A of the bearing 154 extending in the slots 260, 262 are then tightened down once the resilient mount 40 has been shifted to a desired radial position along the mounting plate 126.

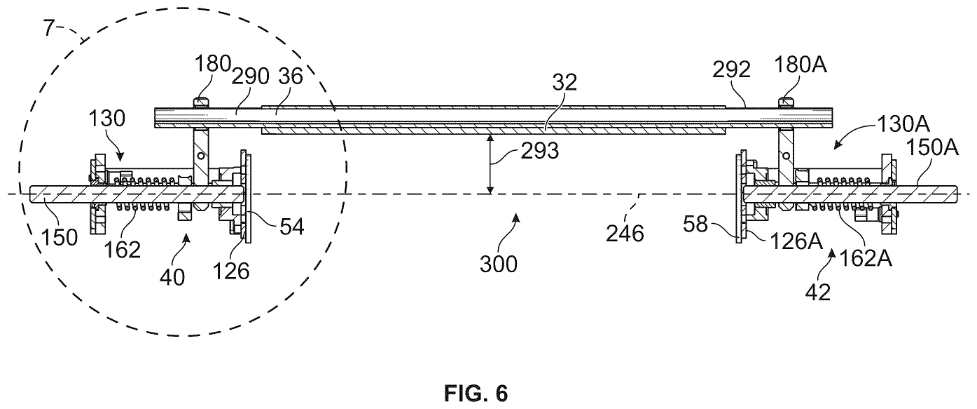

As best seen in FIG. 6, the cleated conveyor belt cleaner 30 has a double crank arm configuration supporting the angle bar 36 and the cleaning blade 32 mounted thereto. Specifically, the angle bar 36 has an end portion 290 secured to the arm 180 of the resilient mount 40 which is in turn secured to the shaft 150. The angle bar 36 has an opposite end portion 292 secured to an arm 180A of the opposite resilient mount 42. The arm 180A is fixed to a shaft 150A of the tensioner 130A of the resilient mount 42. The arms 180, 180A operate as crank arms to transfer the torque applied to the shafts 150, 150A by the torsion springs 162, 162A to the angle bar 36. Further, the rigid connections between the angle bar 36, arms 180, 180A, and shafts 150, 150A balance the forces the arms 180, 180A apply to the angle bar 36 and inhibit twisting of the angle bar 36 and constrain the angle bar 36 and cleaning blade 30 thereon to pivotal movement about the axis 246.

The arms 180, 180A space the angle bar 36 by an offset distance 293 from the pivot axis 246 of the resilient mounts 40, 42 to form a laterally enlarged opening 300 between the resilient mounts 40, 42 and generally aligned in the downstream travel direction from the cleaning blade 32 that permits discharged or scraped objects to travel therethrough. For example and with reference to FIG. 2, the object 18 may be removed by the cleaning blade 32 and travel in direction 99 off of the cleaning blade 32 through the opening 300 and into a receptacle without engaging and/or becoming caught on a structure of the cleated conveyor belt cleaner 30. In other words, there is no cross bar or other structure of the cleated conveyor belt cleaner 30 extending laterally across the cleated conveyor belt 12 where the conveyed objects are being transferred off of the cleated conveyor belt 12. In this manner, the enlarged opening 300 between the resilient mounts 40, 42 permits the cleated conveyor belt cleaner 30 to remove objects and debris from the cleated conveyor belt 12 without causing unwanted accumulation of conveyed objects which could reduce the throughput of the conveyor system 10.

As shown in FIG. 7, the shaft 150 extends through the shaft bushing 152, through an interior 330 of the coils 336 of the torsion spring 162, through an opening 332 of the collar 164, through the opening 190 of the arm 180, and into the bearing 154. The spring coils 336 extend around the shaft 150 and elastically load or unload as the shaft 150 and collar 164 fixed thereto pivot relative to the tensioning hub 160.

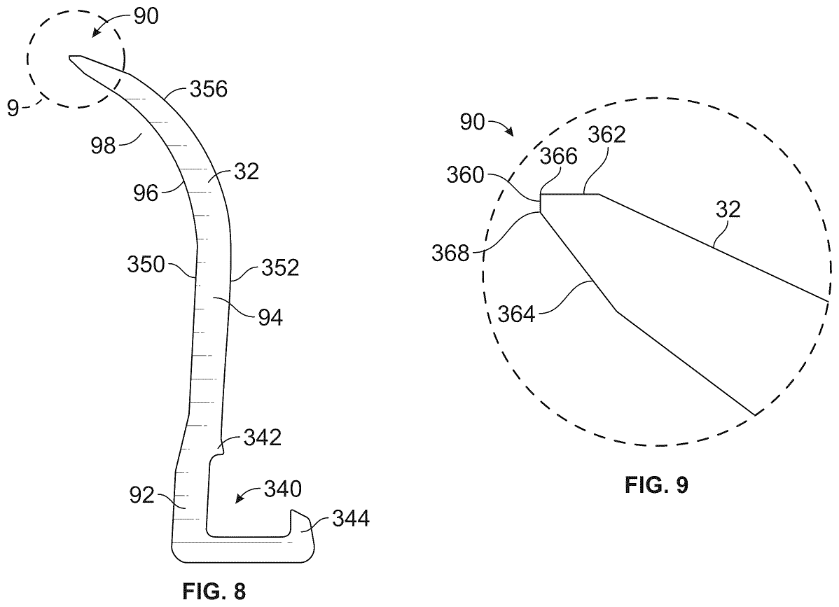

The cleaning blade 32 has a cross section shown in FIG. 8 that is substantially uniform along its laterally extending length. The cleaning blade 32 may be of, for example, a plastic material such as ultra-high-molecular-weight polyethylene (UHMWPE). In other embodiments, the cleaning blade 32 may be made of two or more materials such as a UHMWPE and stainless steel, or urethane and PVC. One material may be used for the scraping tip 90 and another, more resilient material, may be used for the remainder of the cleaning blade 32 as one example.

The lower mounting base portion 92 of the cleaning blade 32 has a recess 340 configured to receive the angle bar 36 and lips 342, 344 that latch onto the ends 204, 206 (see FIG. 4) of the angle bar 36. In one embodiment, the lips 342, 344 permit the cleaning blade 32 to be resiliently snap-fit onto the angle bar 36. Additionally or alternatively, the cleaning blade 32 may be mounted to the angle bar 36 using fasteners, mating portions, or other retention approaches. The cleaning blade 32 may include two or more cleaning blades 32 secured to the angle bar 36.

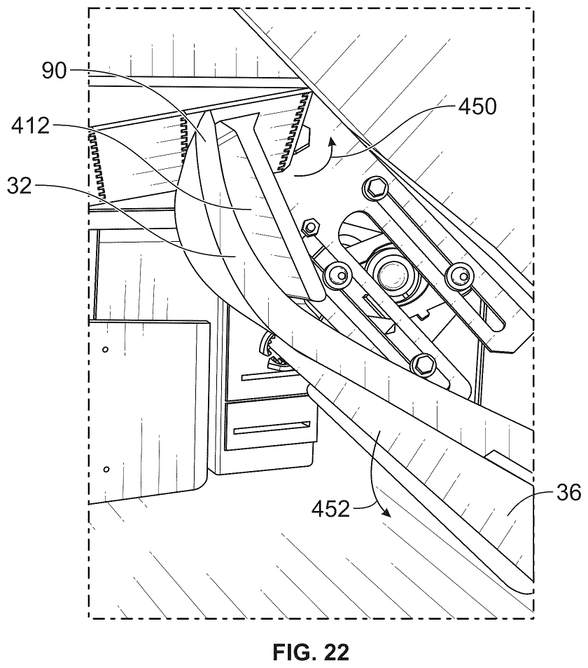

The cleaning blade 32 has an upstream surface 350 that extends from the mounting base portion 92, along the intermediate portion 94, and to the scraping tip 90. The cleaning blade 32 further includes a downstream surface 352 opposite the upstream surface 350. The upstream surface 350 includes the concave upstream surface portion 96 that forms the recess 98 to provide clearance for the free end 76 (see FIG. 1) of the cleat 16 as the base portion 82 of the cleat 16 approaches the scraping tip 90 (see FIG. 22). Conversely, the downstream surface 352 of the cleaning blade 32 has a convex surface portion 356 that converges toward the concave upstream surface portion 96 upwardly along the cleaning blade 32 as they extend toward the scraping tip 90.

Referencing FIG. 9, the scraping tip 90 includes an end surface portion 360 that is oriented to engage the outer surface 34 of the belt portion 14 of the cleated conveyor belt 12. The end surface portion 360 has a slight convex curvature. The end surface portion 360 scrapes along the outer surface 34 of the belt portion 14 and the leading surface 74 of the cleat 16 to remove objects, debris, and/or residue from the cleated conveyor belt 12. Further, the end surface portion 360 provides a larger contact area between the cleaning blade 32 and the outer surface 34 to reduce to reduce peak stresses in the belt portion 14 caused by the biased return of the scraping tip 90 into engagement with the belt portion 14 after the cleat 16 moves past the cleaning blade 32.

The scraping tip 90 further includes inclined surface portions 362, 364 that taper toward each other as the inclined surface portions 362, 364 extend toward the end surface portion 360. The inclined surface portions 362, 364 narrow the scraping tip 90 and provide additional clearance for the end surface portion 360 to remain in contact with the cleated conveyor belt 12 as the end surface portion 360 travels along the outer surface 34 of the belt portion 14, along the leading tapered surface portion 72 (see FIG. 2) of the cleat 16, and onto the leading surface 74 of the cleat 16. More specifically, the inclined surface portion 362 is oriented to avoid or limit contact with the belt portion 14 when the scraping tip 90 scrapes the belt portion 14 and the inclined surface portion 364 is oriented to avoid or limit contact with the leading surface 74 of the cleat 16. The scraping tip 90 has junctures, such as edges 366, 368, connecting the inclined surface portions 362, 364 and the end surface portion surface 360. By limiting contact between the inclined surface portions 362, 364 and the cleated conveyor belt 12, the force from the resilient mounts 40, 42 that urges the cleaning blade 32 into engagement with the cleated conveyor belt 12 is focused at the end surface portion 360 and edge 368 which provides a firm scraping engagement between the scraping tip 90 and the cleated conveyor belt 12.

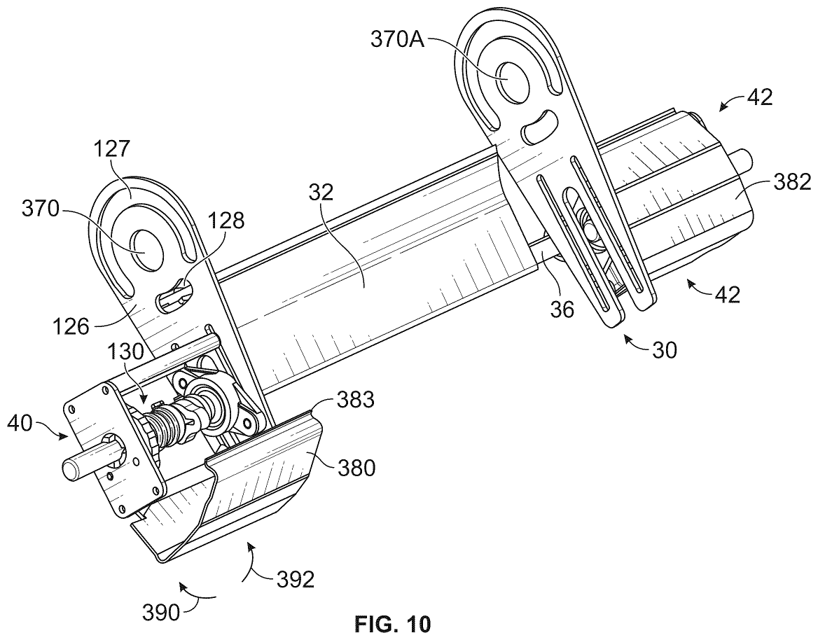

Regarding FIG. 10, the cleated conveyor belt cleaner 30 of FIG. 1 is shown removed from the conveyor frame 50. The cleated conveyor belt cleaner 30 has openings 370, 370A of the mounting plates 126, 126A to receive opposite ends of the shaft 120 of the head pulley 46 in clearance therethrough.

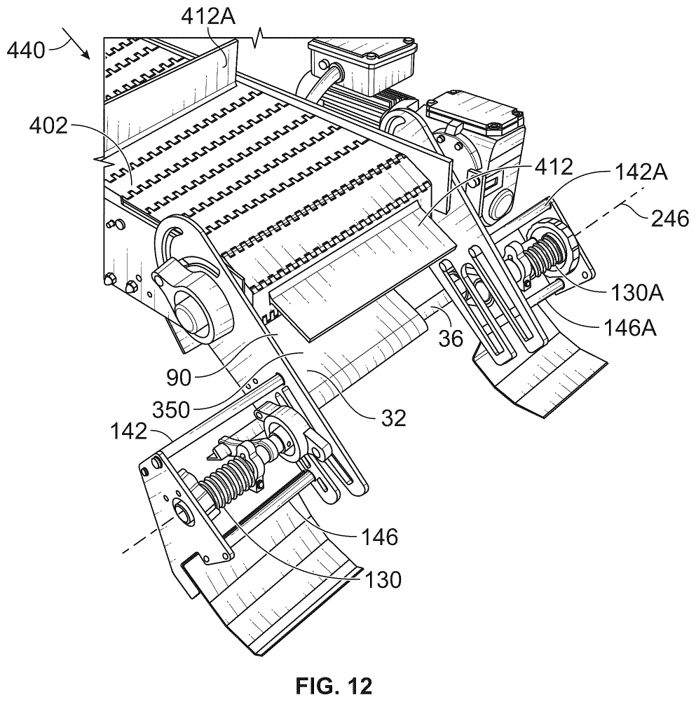

In FIG. 10, the cleated conveyor belt cleaner 30 is shown with optional covers 380, 382 of the resilient mounts 40, 42. The covers 380, 382 are of a resilient construction and are pivotal in direction 390 to an open position as shown with the resilient mount 40. Conversely, the covers 380, 382 may be pivoted in direction 392 to a closed position as shown by the cover 382 of the resilient mount 42. Referring to FIG. 12, the covers 380, 382 are pivotally connected to the support rods 146, 146A of the resilient mounts 40, 42 and have lips 383 (see FIG. 10) that resiliently snap under the support rods 142, 142A to keep the covers 380, 382 in the closed positions.

The covers 380, 382 redirect objects or other debris that were removed by the conveyor belt 12 away from the tensioners 130, 130A and keeps the tensioners 130, 130A from jamming or having a limited range of movement due to objects becoming stuck in the moving components of the tensioners 130, 130A. In this manner, the covers 380, 382 improve the durability of the cleated conveyor belt cleaner 30 in environments where objects may fall off of the cleated conveyor belt 12 laterally outward beyond the skirt walls 52, 54, 56, 58 such as where meat products are being conveyed and where pieces of the meat products may flail as they fall from the cleated conveyor belt 12 in lateral directions. The covers 380, 382 also keep portions of conveyed products or other materials from entering the tensioners 130, 130A which makes the cleated conveyor belt cleaner 30 easier to clean. Further, the covers 380, 382 block access to the moving components of the tensioners 130, 130A which inhibits a user from reaching into the tensioners 130, 130A during conveyor belt operation and getting the user's glove caught in the pinch points of the tensioners 130, 130A.

With respect to FIG. 11, the cleated conveyor belt cleaner 30 is shown integrated into another conveyor system 400 that includes a cleated conveyor belt 402. The cleated belt 402 has a belt portion 404 formed by belt sections or segments 406 pivotally connected via hinge connections 410. Some of the belt segments 406 have upstanding cleats 412, 412A to support objects as they are conveyed by the cleated conveyor belt 402. The tensioners 130, 130A of the resilient mounts 40, 42 urge the angle bar 36 and the cleaning blade 32 mounted thereto in rotary direction 420 to bring the scraping tip 90 into scraping engagement with an outer surface 422 of the belt portion 404. The tensioners 130, 130A permit the cleaning blade 32 to pivot slightly backward in rotary direction 452 against the bias force provided by the tension springs 130, 130A when the scraping tip 90 encounters the hinge connections 410, but otherwise biases the cleaning blade 32 in rotary direction 420 to keep the scraping tip 90 engaged with the outer surface 422 of the belt 404. As shown in FIG. 11, objects, such as meat carried on the outer surface 422, may be removed by the cleaning blade 32 and travel generally in direction 430 along the upstream surface 350 of the cleaning blade 32 away from the cleated conveyor belt 402. The removed object may then fall through the opening 300 between the mounting plates 126, 126A of the cleated conveyor belt cleaner 30 and into or onto downstream equipment such as a conveyor, a grinder, or a receptacle such as a cart.

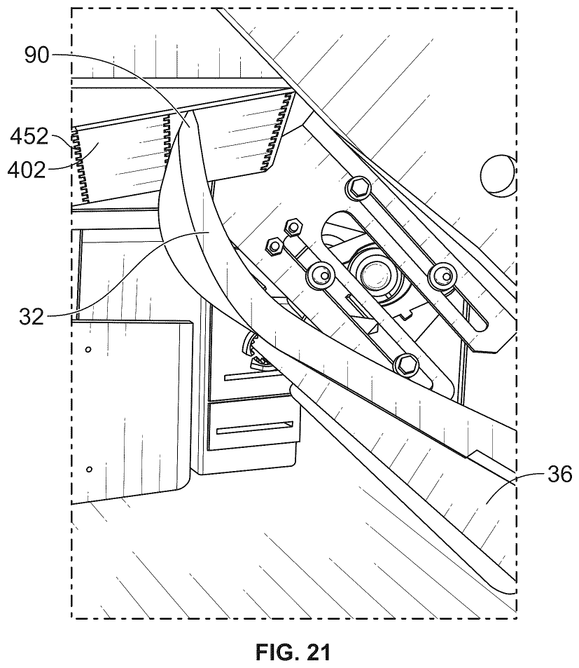

Regarding FIG. 12, as the cleated belt 402 is driven in a downstream, longitudinal direction 440, the cleat 412 approaches the cleaning blade 32. FIG. 21 shows the scraping blade 90 engaged with the outer surface 422 of the cleated conveyor belt 402 before the cleat 412 reaches the cleaning blade 32.

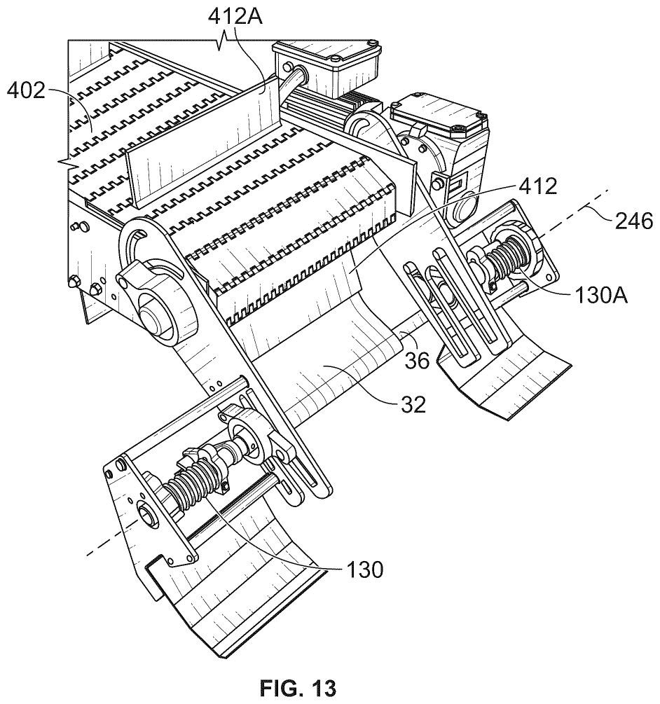

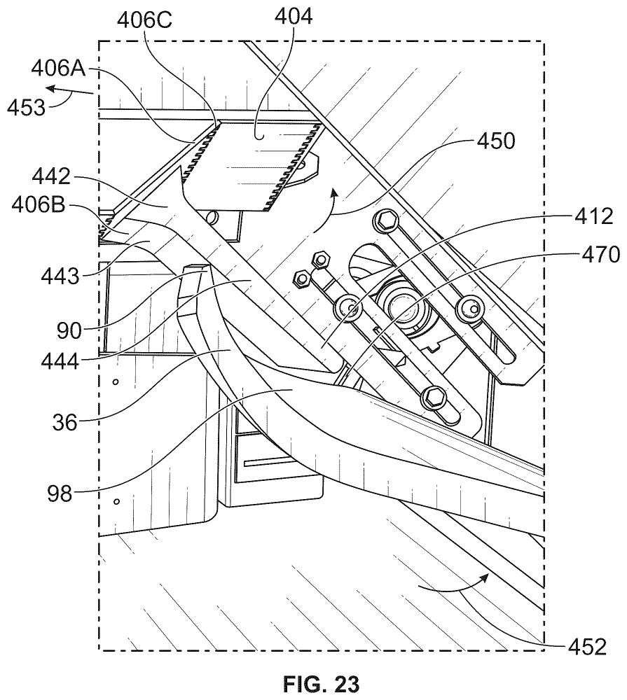

Regarding FIG. 13, the scraping tip 90 is shown scraping the outer surface 422 of the cleated conveyor belt 402 up to and onto a base 442 of the cleat 412. FIG. 22 shows the scraping tip 90 scraping a tapered leading surface portion 443 (see FIG. 23) of the base 442. The concave upstream surface portion 96 (see FIG. 2) and associated recess 98 of the cleaning blade 32 avoid contact between the cleat 412 and the cleaning blade 32 except for the scraping tip 90 against the base 442 of the cleat 412. Avoiding such contact between the cleat 412 and the cleaning blade 32 permits the cleaning blade 32 to scrape the outer surface 422 of the belt portion 404 up to the cleat 412 without the cleat 412 deflecting the cleaning blade 32 and potentially reducing the force with which the scraping tip 90 engages the belt portion 404 or moving the scraping tip 90 entirely out of engagement with the outer surface 422.

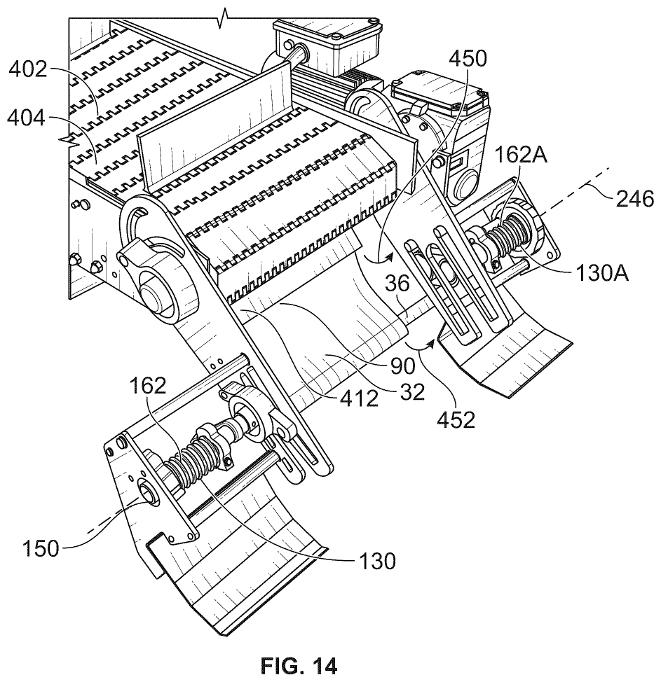

Regarding FIGS. 14 and 23, the scraping tip 90 is shown scraping along the leading surface 444 of the cleat 412. The cleat 412 has an upstanding configuration from the belt portion 404 such that the tension applied to the cleaning blade 32 by the tensioners 130, 130A pivots the cleat 412 in upstream direction 450 when the cleaning blade 32 engages the cleat 412. The cleat 412 is rigidly upstanding from the associated belt segment 406A such that the belt segment 406A shifts or buckles to accommodate for pivoting of the cleat 412. More specifically, a leading end 406B of the belt segment 406A shifts downwardly in FIG. 23 and a trailing end 406C shifts upwardly via the hinge connections 410 with the adjacent belt segments 406 to allow the cleat 412 to pivot in direction 450. The pivoting of the cleat 412 in the upstream direction 450 orients the upstream surface 444 of the cleat 412 to operate as a ramp or incline for the cleaning blade 32 as the cleat 412 travels in a downstream direction 453 (see FIG. 23). Concurrently, the tensioners 130, 130A permit the cleaning blade 32 to pivot against their bias force in direction 452 away from the belt portion 404 as the cleaning blade 32 travels over the inclined upstream surface 444 of the cleat 412 with the cleat 412 traveling in the downstream direction 453 thereby keeping the cleaning blade 32 from getting hung up on the cleat 412.

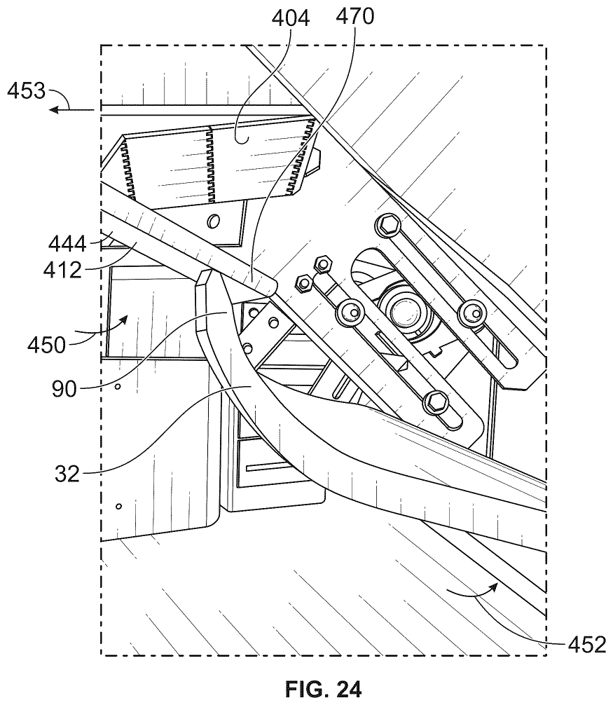

Specifically, the inclined upstream surface 444 of the deflected cleat 412 moves in the downstream direction 453 (see FIGS. 23-25) and cams the cleaning blade 32 away from the belt portion 404 of the cleated conveyor belt 412. The camming engagement between the inclined upstream surface 444 of the deflected cleat 412 and the cleaning blade 32 causes the cleaning blade 32 to urge the angle bar 36 away from the belt portion 404. Because the angle bar 36 is constrained to pivotal movement about the pivot axis 246, the cleaning blade 32 pivots in direction 452 away from the belt portion 404. Pivoting of the angle bar 36 in direction 452 causes turning of the shafts 150, 150A and further loads the torsion springs 162, 162A.

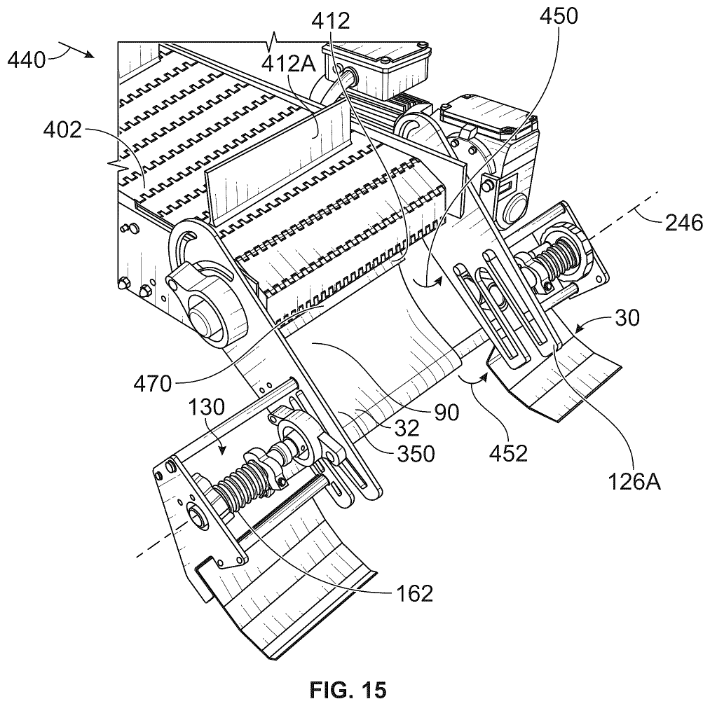

Regarding FIGS. 15, 24, and 25, the scraping tip 90 is shown scraping along the leading surface 444 of the cleat 412 and reaching a free end 470 of the cleat 412. The cleaning blade 32 has been pivoted in the direction 452 to a maximum distance away from the belt portion 404 and the cleat 412 has been deflected in direction 450 to extend at an approximately 45 degree angle relative to an undeflected section of the belt portion 404.

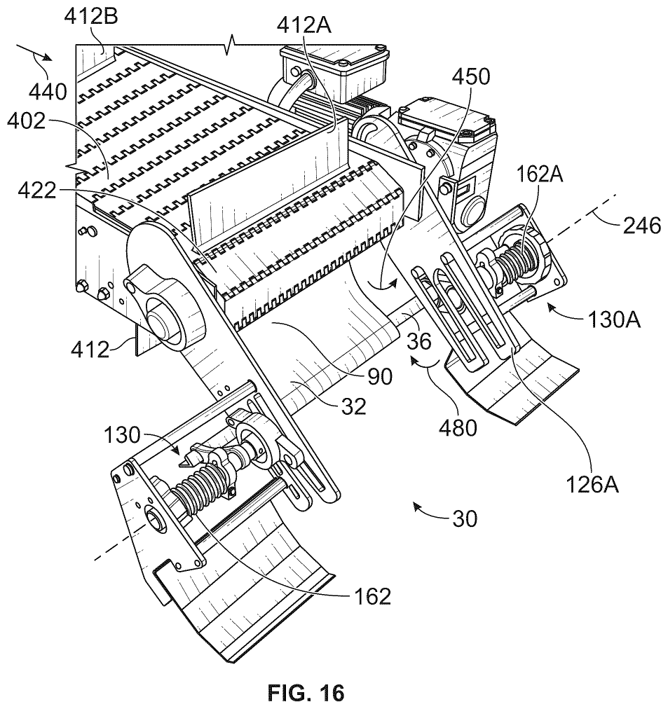

Regarding FIGS. 16, 26, and 27, the scraping tip 90 is shown sliding off of the free end 470 of the cleat 412 and being resiliently returned into engagement with the belt portion 404 of the cleated conveyor belt 402 via the biasing force applied by the tensioners 130, 130A. More specifically, once the cleaning blade 32 disengages from the cleat 412, the tensioners 130, 130A pivot the cleaning blade 32 back in direction 480 which partially unloads the torsion springs 162, 162A. The tensioners 130, 130A return the scraping tip 90 of the cleaning blade 32 back into engagement with the outer surface 422 of the belt 404 to resume scraping removal of objects, debris, and/or residue from the belt 404. The belt segment 406A including the cleat 412 shifts back in direction 481 (see FIG. 26) once the cleaning blade 32 disengages from the cleat 412. The process repeats when the cleaning blade 32 encounters the next cleats 412A, 412B (see FIG. 16).

Regarding FIGS. 17-20, the resilient mount 40 is shown as the cleaning blade 32 scrapes the belt portion 404, encounters a cleat 412, travels over the cleat 412, and subsequently re-engages the belt portion 404. More specifically and with respect to FIG. 17, the arm 180 and shaft 150 are in an initial position wherein the spring 162 is applying a torque to the arm 180 and an initial force on the cleaning blade 32 due to the initial preload applied to the spring 162 during installation of the cleated conveyor belt cleaner 30.

When the scraping tip 90 of the cleaning blade 30 engages the base 442 of the cleat 412 (scc FIGS. 21-23), the cleaning blade 32 shifts away from the belt portion 404 against the applied torque which causes the arm 180 to pivot in direction 452. Due to the fixed connections between the arm 180, shaft 150, and collar 164, the pivoting of the arm 180 in direction 452 causes the shaft 150 and the collar 164 to also pivot or rotate in direction 452 as the cleaning blade 32 is urged away from the belt portion 404 by the cleat 412. Because the end 170 (see FIG. 3) of the torsion spring 162 is fixed to the collar 164, the pivoting of the collar 164 in direction 452 likewise moves the end 170 in direction 452 while the end 166 of the torsion spring 162 remains stationary and fixed to the tensioning hub 160 (see FIG. 3). The rotary movement of the end 170 relative to the end 166 of the torsion spring 162 causes the coils 336 of the torsion spring 162 to decrease in diameter to further load the torsion spring 162 beyond the initial load applied during installation of the cleated conveyor belt conveyor 30.

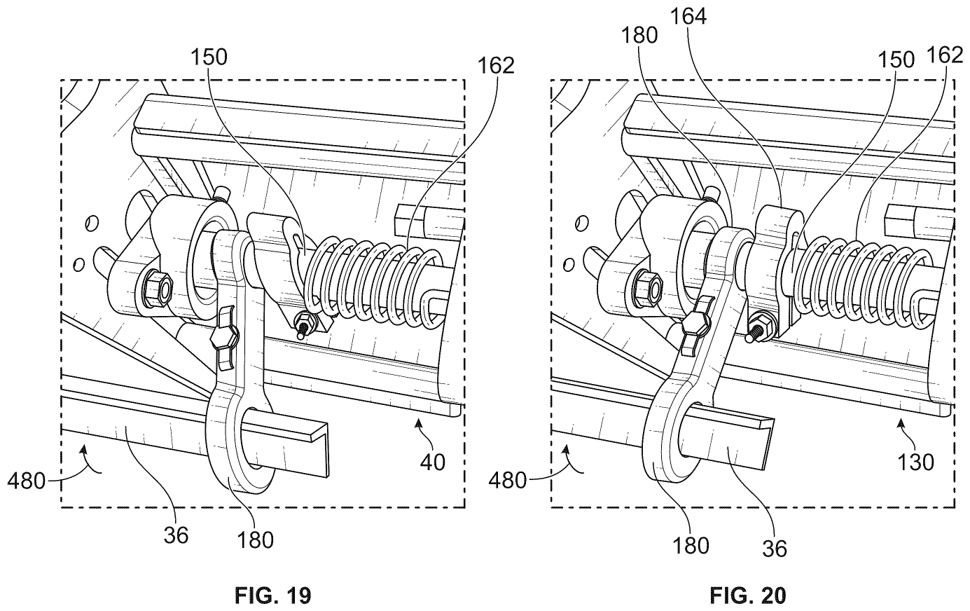

Regarding FIG. 19, the resilient mount 40 is shown when the scraping tip 90 of the cleaning blade 30 has reached the free end 470 of the cleat 412 (see FIGS. 15 and 25). The arm 180 has been pivoted in the direction 452 to a position that permits the cleaning blade 32 to travel over the cleat 412 and imparts a maximum contraction of the diameter of the coils 336 of the torsion spring 162.

As the cleat 412 moves in downstream direction 453, the scraping tip 90 slides off the cleat 412 and the cleat 412 no longer deflects the cleaning blade 32 away from the belt portion 404. Regarding FIG. 20, the tensioner 130 resiliently urges the arm 180 back in direction 480 as the torsion spring 162 partially unloads and returns the shaft 150, collar 164, arm 180, angle bar 36, and cleaning blade 32 back to the initial positions thereof as shown in FIG. 17.

Although the cleat 412 is shown being deflected from an initial configuration of 90 degrees (see FIG. 11) relative to the belt portion 404 to a deflected configuration of approximately 45 degrees (see FIG. 25) relative to the belt portion 404, the initial and deflected configurations of the cleat 412 will vary for different conveyor belts and the cleated conveyor belt cleaner 30 accommodates varying amounts of deflection of the cleats. For example, the cleats of a conveyor belt may not pivot upstream as the cleaning blade 32 scrapes the leading surfaces of the rigid cleats. The cleated conveyor belt cleaner 30 can still be installed to scrape the cleated conveyor belt with cleats that do not pivot upstream, with the installer adjusting the components of the cleated conveyor belt cleaner 30 to permit the cleaning blade 32 to pivot farther in direction 452 to travel over the rigid cleats. As an example in this regard, the cleaning blade 32 may engage the cleated conveyor belt where the cleated conveyor belt is supported by a head pulley or other sprocket such that the belt segment associated with each cleat is unable to shift or buckle to permit the cleat to pivot upstream.

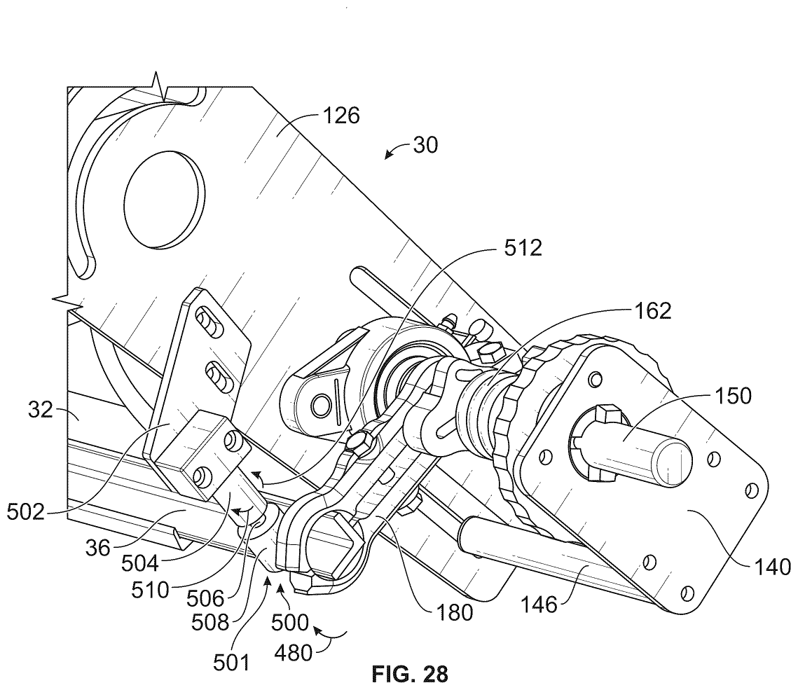

With reference to FIG. 28, in one embodiment, the cleated conveyor belt cleaner 30 includes a dampener 500 to dampen movement of the cleaning blade 32 as the cleaning blade 32 travels back into engagement with the belt portion 404 after the cleaning blade 32 has been deflected by the cleat 412 (see FIGS. 25-27). The dampener 500 thereby reduces the force with which the cleaning blade 32 contacts the belt portion 404 to reduce wear on the cleated conveyor belt 402 and reduce the noise caused by the cleaning blade 32 snapping back into engagement with the belt portion 404.

In one embodiment, the dampener 500 may be configured to provide a stop for the cleaning blade 32 that spaces the scraping tip 90 a predetermined distance from the belt portion 404 of the cleated conveyor belt 402. The dampener 500 thereby dampens movement of the cleaning blade 32 by restricting movement of the cleaning blade 32 including stopping the scraping tip 90 from moving into contact with the belt portion 404 of the cleated belt 402.

The cleaning blade 32 returns in direction 480 (see FIG. 25-26) until the angle bar 36 abuts the dampener 500. The dampener 500 absorbs the impact force from the angle bar 36 as the tensioners 130, 130A resiliently urge the angle bar 36 in direction 480 after the cleaning blade 32 has been deflected by the cleats 412, 412A, 412B. Although the scraping tip 90 is spaced from the belt portion 404 when the angle bar 36 abuts the dampener 500, the scraping tip 90 is positioned to scrape the leading surfaces 414 of the cleats 412, 412A, 412B.

Regarding FIG. 28, the dampener 500 includes a mount 502 for being secured to the mounting plate 126, a support 504, and a bumper 501 connected thereto. In one embodiment, the support 504 includes a threaded female bore and the bumper 501 includes a resilient member 508 connected to a threaded shank 506. The resilient member 508 may be made of a resilient material such as rubber, and the threaded shank 506 may be made of a metallic material. Turning of the resilient member 508 and threaded shank 506 connected thereto in directions 510, 512 shifts the resilient member 508 away from or toward the support 504. By adjusting the resilient member 508 to be farther away from the support 504, the resilient member 508 can be positioned to abut the angle bar 36 and stop further movement of the angle bar 36 in direction 480 before the cleaning blade 32 engages the belt portion 404.

Conversely, shifting the resilient member 508 toward the support 504 allows the resilient member 508 to be positioned to abut the cleaning blade 32 when the cleaning blade 32 contacts, such as slightly contacts, the belt portion 404. The resilient member 508 may thereby operate as a stop to inhibit the cleaning blade 32 from impacting the belt portion 404 with the full force imparted by the tensioners 130, 130A while permitting the cleaning blade 32 to perform some cleaning of the belt portion 404 and the cleats 412, 412A, 412B. The side plate 140 of the cleated conveyor belt cleaner 30 shown in FIG. 28 has an offset configuration that positions the shaft 150 toward one end of the side plate 140, with the other end of the side plate 140 being supported by 142 and 146.

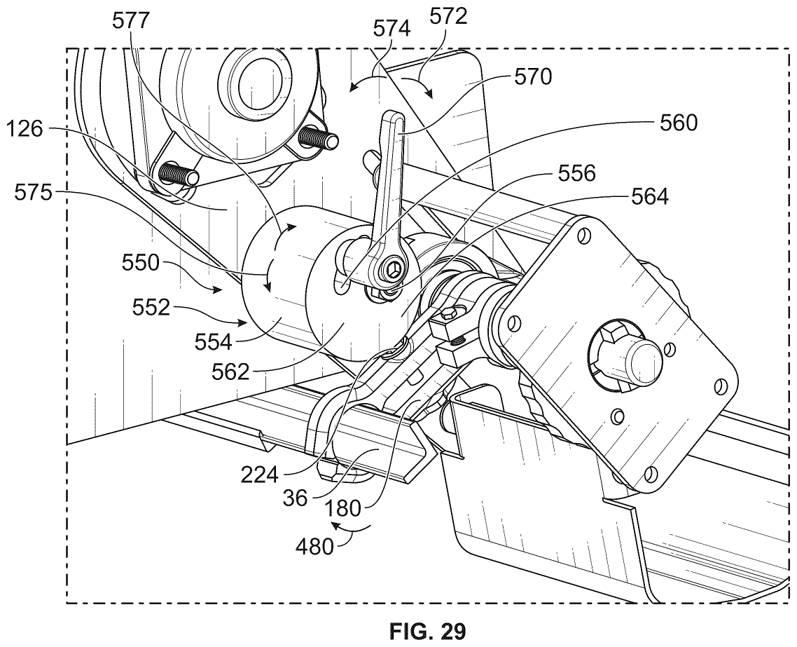

Regarding FIG. 29, in another embodiment of the cleated conveyor belt 30 includes a dampener 550 having a resilient bumper 552 with a stop surface 554 to contact the arm 180 and limit movement of the arm 180 in direction 480. The cleated conveyor belt cleaner 30 may have two dampeners 550, one dampener to contact arm 180 and another dampener to contact arm 180A. In FIG. 29, the bumper 552 has a cylindrical stop surface 554 that abuts the nut 224 or bolt 220 of the arm 180 to limit movement of the arm 180 and angle bar 36 secured thereto in direction 480. The bumper 552 is made of a resilient material such as a plastic, rubber, or composite material.

The bumper 552 has an eccentric pivot connection 556 to the mounting plate 126 that is eccentric to a center of the cylindrical stop surface 554. The bumper 552 may be about the eccentric pivot connection 556 during installation of the cleated conveyor belt cleaner 30 to impart the desired dampening of the return of the cleaning blade 32 in direction 480. The eccentric pivot connection 556 may include a bolt extending through an opening of the bumper 552 and a nut/washer assembly securing the bumper 552 to the bolt. The bumper 552 includes an arcuate slot 560, a thicker portion 562, and a thinner portion 564.

The dampener 550 includes a clamp handle 570 having a threaded shank that extends through the arcuate slot 560 and engages a threaded hole of the mounting plate 126. The clamp handle 570 may be pivoted in direction 572 to clamp the bumper 552 between the clamp handle 570 and the mounting plate 126 and fix the bumper 552 against rotation relative to the mounting plate 126. The clamp handle may be pivoted in direction 574 to release the bumper 552 and permit a user to turn the bumper 552 about the eccentric pivot connection 556 relative to the mounting plate 126.

The user may pivot the bumper 552 in direction 575 to orient the thicker portion 562 to abut the arm 180, which causes the cleaning blade 32 to stop its return in direction 480 farther away from the belt portion 404 such that the cleaning blade 32 is spaced from the belt portion 404 when the thicker portion 562 abuts the arm 180. Conversely, the user may pivot the bumper 552 in direction 577 to orient the thinner portion 564 to abut the arm 180, which causes the cleaning blade 32 to contact (e.g., slightly contact) the belt portion 404 when the thinner portion 564 abuts the arm 180. Once the desired portion of the bumper 552 is oriented to abut the arm 180, the user pivots the clamp handle in direction 572 to clamp the bumper 552 in position. In one embodiment, the bumper 552 may be turned to a clearance position wherein the bumper 552 is out of the way of the arm 180 and permits the cleaning blade 32 to have an unrestricted range of motion such that the cleaning blade 32 engages the belt portion 404.

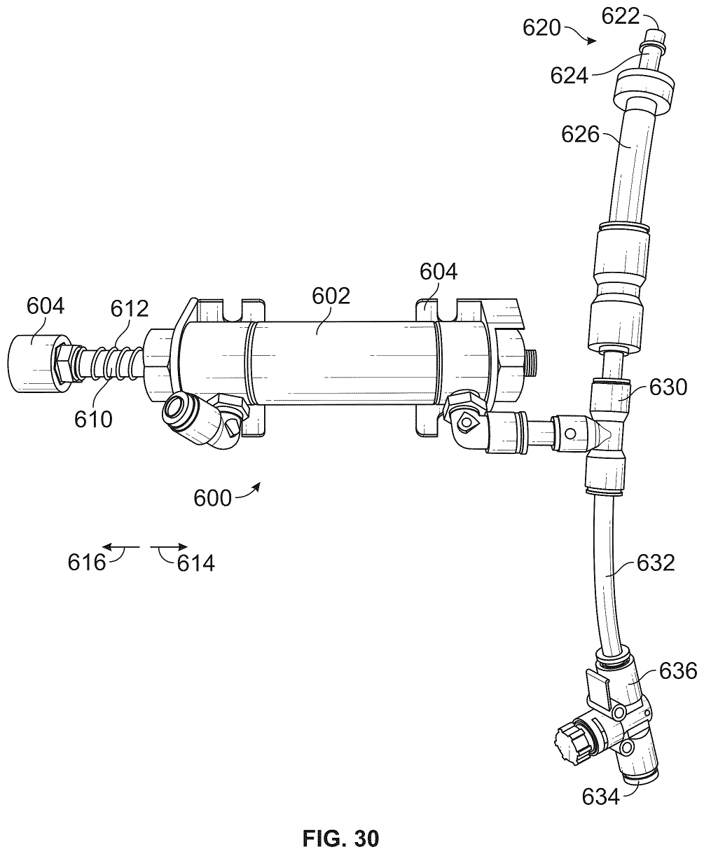

With reference to FIG. 30, a dampener 600 is provided that may be utilized to slow movement of the cleaning blade 32 in direction 480. The dampener 600 includes a pneumatic cylinder 602 with a bracket 604 to be mounted to the mounting plate 126 of the cleated conveyor belt cleaner 30 and a bumper 606 to engage the angle bar 36 as the angle bar 36 returns in direction 480. The dampener 600 includes a spring 612 that resists movement of the piston 610 in direction 614 while providing a bias force to urge the piston 610 back in direction 616. The dampener 600 includes an air inlet 620 having an inlet opening 622 and a check valve 624. The check valve 624 permits air to enter the air inlet 620 but inhibits the flow of air out from the air inlet 620.

When the angle bar 36 pivots in return direction 480 into contact with the bumper 604, the angle bar 36 shifts the bumper 604 and piston 610 in direction 614. The piston 614 drives air out from the pneumatic cylinder 602 into a fitting 630, through a tube 632, and out through an outlet such as an orifice 634 of fitting 636. Because the check valve 624 inhibits air from exiting the inlet opening 622, the air being driven from the pneumatic cylinder 602 by the piston 610 shifting in direction 614 exits the dampener 600 via the orifice 634. The orifice 634 is sized to limit the flow of air from the pneumatic cylinder 602 and provide sufficient resistance to movement of the piston 610 in direction 614. The resistance to movement of the piston 610 in direction 614 imparted by the air in the pneumatic cylinder 602 dampens movement of the angle bar 36 and reduces the velocity with which the cleaning blade 32 returns in direction 480 into engagement with the belt portion 404 of the cleated conveyor belt 402.

Once the cleaning blade 32 has returned into engagement with the belt portion 404 of the cleated conveyor belt 402, the angle bar 36 keeps the piston 610 shifted in direction 614 until the cleaning blade 32 and angle bar 36 are deflected away from the belt portion 404 in direction 452 by the cleat 412 (see FIGS. 22-23). Pivoting of the angle bar 36 in direction 452 moves the angle bar 36 out of engagement with the bumper 604 and permits the spring 612 to shift the piston 610 and bumper 604 thereon in direction 616. As the piston 610 shifts in direction 616, the piston 610 draws air into the pneumatic cylinder 602 via the air inlet opening 622 of the check valve 624.

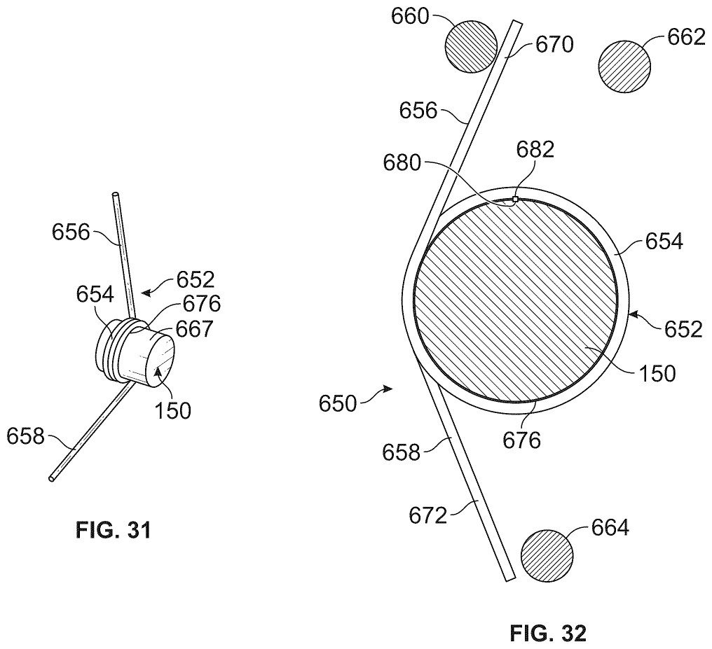

Regarding FIGS. 31 and 32, the cleated conveyor belt cleaner 30 may include a dampener such as a wrap spring brake 650 for slowing the rotational velocity of the shaft 150 as the shaft 150 turns in direction 480 and returns the cleaning blade 32 into engagement with the belt portion 404 of the cleated conveyor belt 402. The wrap spring brake 650 includes a wrap spring 652 having coils 654, a clockwise (CW) control tang 656 and a counterclockwise (CCW) control tang 658. The wrap spring brake 650 further includes a spring tensioning stop 660, a CW control tang stop 662, and a CCW control tang stop 664 that are mounted to a stationary portion of the cleated conveyor belt cleaner 30, such as the mounting plate 126 or side plate 140. The stops 660, 662, 664 may include rods, protrusions, flats, or other members configured to limit movement of end portions 670, 672 of the CW and CCW control tangs 656, 658 as discussed in greater detail below.

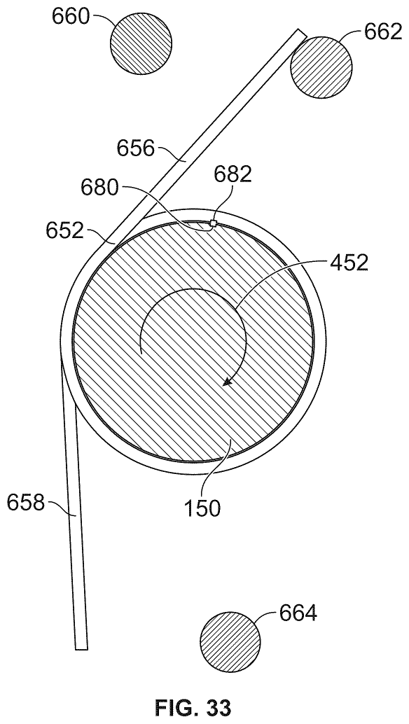

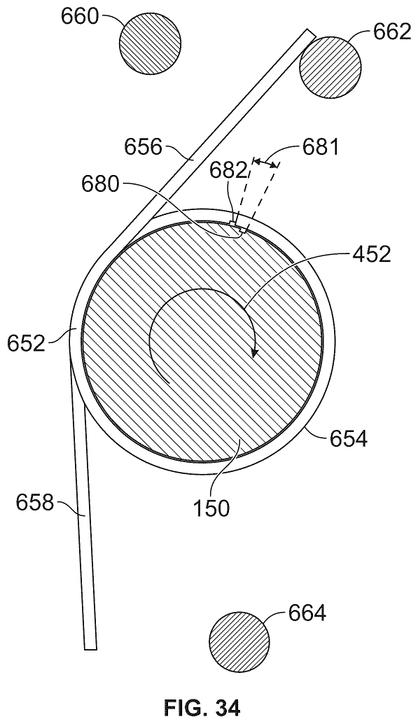

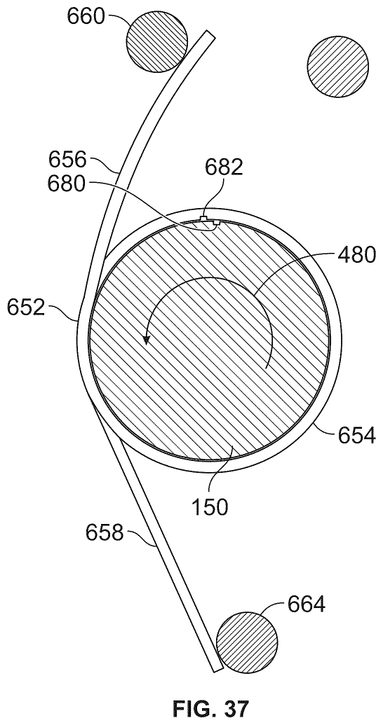

Regarding FIG. 31, the coils 654 of the wrap spring 652 have a central opening 676 through which the shaft 150 extends. The shaft 150 has an outer cylindrical surface 677 with an outer diameter that is slightly larger than an undeflected inner diameter of the coils 654. Thus, when the shaft 150 is positioned in the central opening 676 of the wrap spring 652, the coils 654 are slightly deflected and tightly engage the outer cylindrical surface 677 of the shaft 150. The coils 654 are wound to increase in inner diameter when the CW control tang 656 abuts the CW control tang stop 662 and the shaft 150 turns in direction 452 (see FIGS. 33-34). When the coils 654 increase in inner diameter, the coils permit the cylindrical outer surface 677 of the shaft 150 to turn relative to the coils 654. Similarly, the coils 654 are wound to increase in diameter when the CCW control tang 658 abuts the CCW control stop 664 and the shaft 150 turns in direction 480 (see FIGS. 37-38). Further, the coils 654 are wound to maintain their inner diameter when the CW control tang 656 abuts the spring tensioning stop 660 and the shaft 150 turns in direction 480.

More specifically and with reference to FIG. 32, the wrap spring brake 650 is shown in an initial configuration that corresponds to when the cleaning blade 32 is engaged with the belt portion 404 of the cleated conveyor belt 402. In the initial configuration, the wrap spring 652 is at a rotational position of 0°, the shaft 150 is at a rotational position of 0°, and the end portions 670, 672 of the wrap spring 652 are proximate the spring tensioning stop 660 and the CCW control tang stop 664. The wrap spring 652 is cinched onto and fixed relative to the shaft 150.

Regarding FIGS. 32 and 33, the cleaning blade 32 has encountered the cleat 412, which causes the arm 180 and shaft 150 connected to the blade 32 to turn in direction 452. Turning of the shaft 150 in direction 452 from the position of the shaft 150 in FIG. 32 causes turning of the wrap spring 652 in direction 452 because the coils 654 of the wrap spring 652 are cinched onto the shaft 150. The turning of the shaft 150 and wrap spring 652 together in direction 452 brings the CW control tang 656 into contact with the CW control tang stop 662 as shown in FIG. 33.

Regarding FIGS. 33 and 34, the shaft 150 continues to turn in direction 452 as the cleaning blade 32 is urged farther away from the belt portion 404 by the cleat 412. Because the CW control tang 656 has engaged the CW control tang stop 662, the wrap spring 652 remains stationary as the shaft 150 continues to turn in direction 452. As noted above, the winding of the coils 654 causes the inner diameter of the coils 654 to increase as the shaft turns in direction 452 and the CW control tang 656 abuts the CW control tang stop 662. The increase in the inner diameter of the coils 654 permits the cylindrical outer surface 677 of the shaft 150 to slide relative to the coils 654 and facilitates turning of the shaft 150 in direction 452 while the wrap spring 652 remains stationary.

Regarding FIGS. 33 and 34, the turning of the shaft 150 in direction 452 relative to the wrap spring 652 while the CW control tang 656 abuts the CW control tang stop 662 causes a notch 680 in the cylindrical outer surface 677 of the shaft 150 to turn an angle 681, such as 5°, out of radial alignment with a notch 682 on a radially inner surface of one of the coils 654 of the wrap spring 652. In FIG. 34, the shaft 150 has turned relative to the coils 654 of the wrap spring 652 such that the shaft 150 is at a position of +30° while the wrap spring 652 is at a position of +25°.

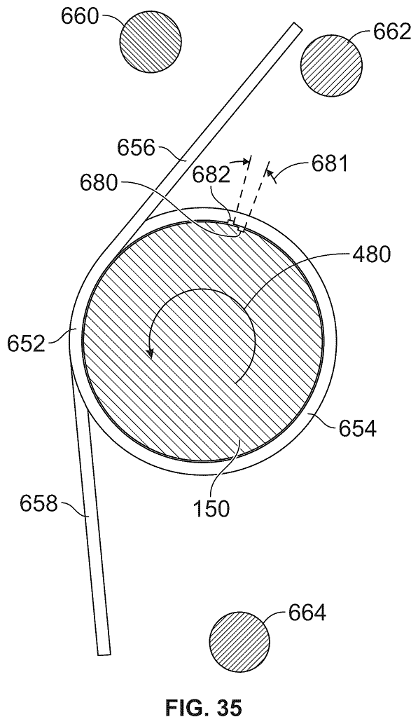

Regarding FIG. 35, the torsion spring 162 begins turning the shaft 150 in direction 480 to return the cleaning blade 32 back into engagement with the belt portion 404 of the cleated conveyor belt 402. Because neither of the CW and CCW control tangs 656, 658 are contacting the CW and CCW control tang stops 662, 664, the coils 654 can partially unload and cinch back into engagement with the shaft 150 as the shaft 150 turns in direction 480. In this manner, the wrap spring 652 turns with the shaft 150 in direction 480 but at a rotational orientation that is −5° from the rotational orientation of the shaft 150 due to the disengagement of the wrap spring 652 that occurred in FIGS. 33-34. In FIG. 35, the wrap spring 652 is at a rotary position of +20° and the torque shaft 150 is at a rotary position of +25°.

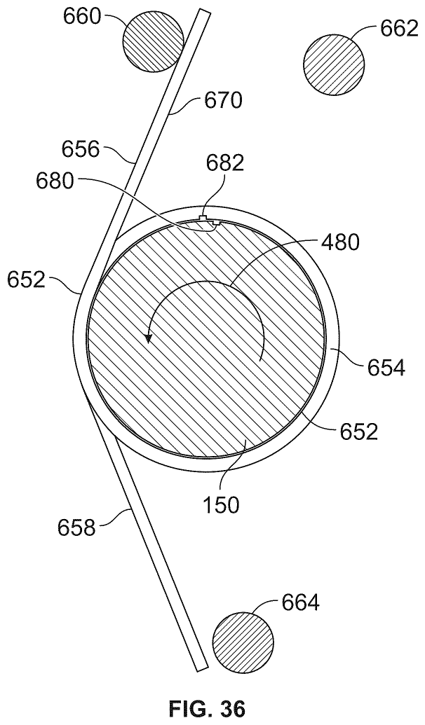

Regarding FIG. 36, the shaft 150 has continued to turn in direction 480 and the CW control tang 656 has moved into abutting contact with the spring tensioning stop 660. The coil 654 is still cinched onto and fixed relative to the outer cylindrical surface 677 of the shaft 150. In FIG. 36, the wrap spring 652 is at a rotary position of 0°, and a shaft 150 is at rotary position of +5°.

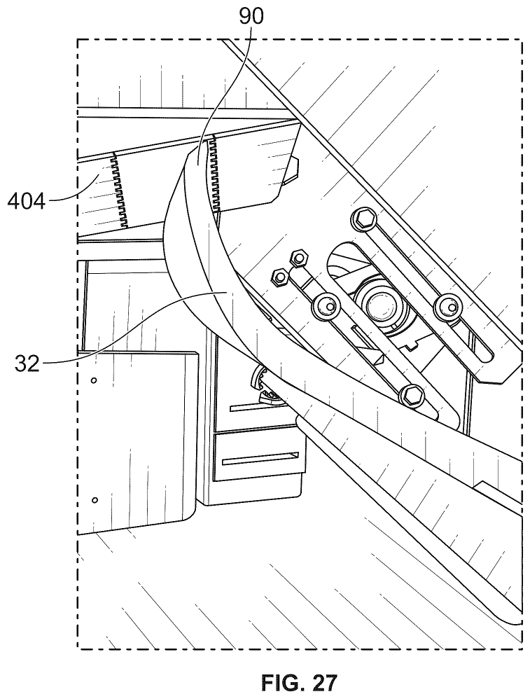

Regarding FIG. 37, the cleaning blade 32 is about to re-engage the belt portion 404 of the cleated conveyor belt 402. The shaft 150 continues to turn in direction 480 but the CW control tang 656 abuts the spring tensioning stop 660 and the CCW control tang 658 begins to engage the CCW control stop 664. The coils 654 are still cinched onto and fixed relative to the shaft 150 and the CW control tang 656 bends as shown in FIG. 37. The bending of the CW control tang 656 while the coils 654 are fixed relative to the shaft 150 resiliently resists turning of the shaft 150 in direction 480, which slows the rotation of the shaft 150 as well as the movement of the cleaning blade 32 back into engagement with the belt portion 404 of the cleated conveyor belt 402. In this manner, the wrap spring brake 650 slows rotation of the shaft 150 and associated pivoting of the cleaning blade 32 in direction 480 (see FIGS. 26 and 27) as the scraping blade 32 approaches the belt portion 404.

Regarding FIG. 37, the CCW control tang 658 has just started to engage the CCW control stop 664. As the shaft 150 turns in direction 480 and is slowed by the bending CW control tang 656, the CCW control tang 658 is pressed more firmly against the CCW control stop 664. Due to the winding of the coils 654, the combination of the shaft turning in direction 480 and the CCW control tang 658 engaging the CCW control tang stop 664 causes the inner diameter of the coils 654 to increase and permit turning of the shaft 150 in direction 480 an angle of −5° relative to the wrap spring 652.

Regarding FIG. 38, the shaft 150 and wrap spring 652 have returned to the initial configuration where both the shaft 150 and wrap spring 652 are at 0°. The CCW control tang 658 has disengaged from the CCW control tang stop 664 which causes the coils 654 to decrease in inner diameter and cinch onto the shaft 150. At this point, the wrap spring brake 650 is ready for the cleaning blade 32 to contact another cleat 412A, 412B.

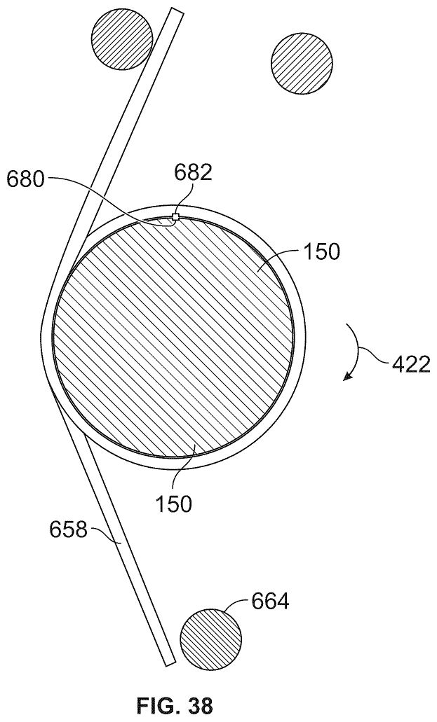

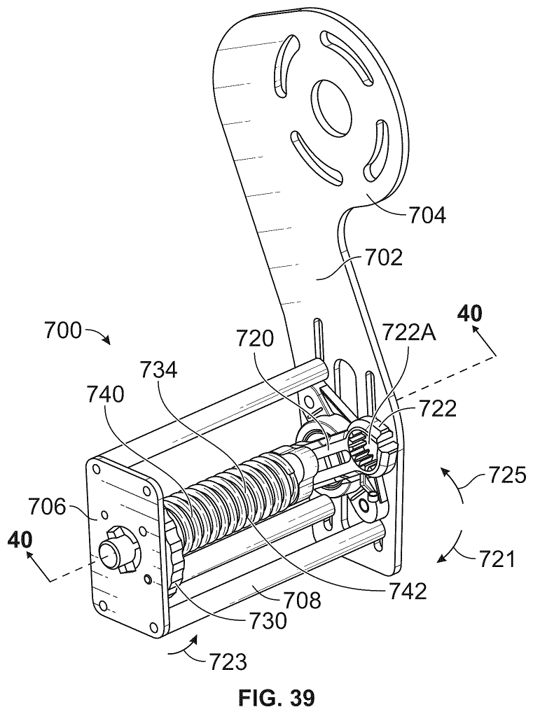

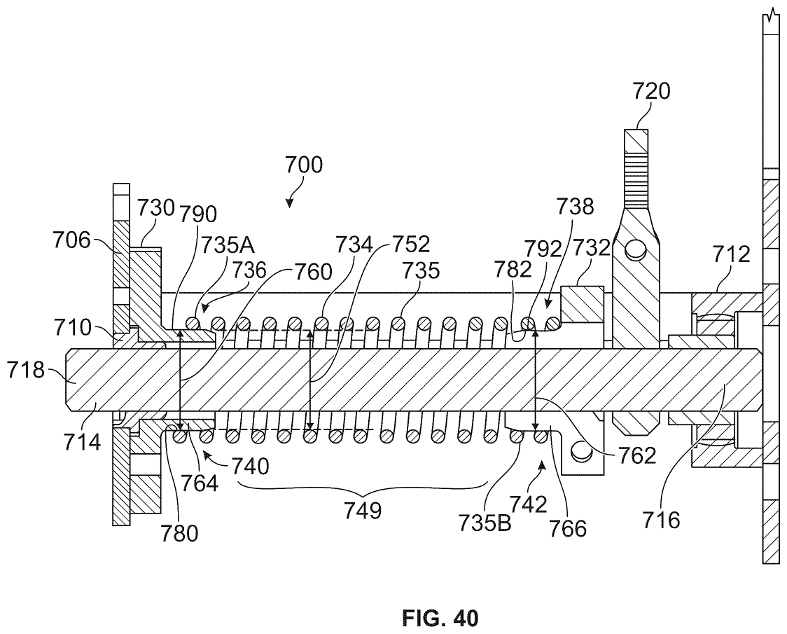

Referring next to FIGS. 39 and 40, a resilient mount 700 is shown that is similar in many respects to the resilient mounts discussed above for cleated conveyor belt cleaners. The resilient mount 700 includes a bracket, such as a mounting plate 702, with an upper mounting portion 704 to be secured to a conveyor structure, a side plate 706, and support rods 708 connecting the mounting plate 702 and the side plate 706. The resilient mount 700 includes a shaft bushing 710 and a bearing 712 that rotatably support opposite end portions 714, 716 of a shaft 718 of the resilient mount 700. The resilient mount 700 includes an arm 720 with an arcuate end portion 722 having an opening 722A for receiving an angle bar that supports a cleaning blade. The arm 720 is configured to be fixed to the shaft 718 such that the arm 720 and shaft 718 pivot together in directions 721, 725 (see FIG. 39) as the cleaning blade engages and travels along and around a conveyor belt cleat, as described earlier herein.

Continuing reference to FIG. 40, the resilient mount 700 includes a tensioning member such as a tensioning hub 730, a spring mount member such as a split collar 732, and a torsion spring 734. The tensioning hub 730, split collar 732, and torsion spring 734 may be made of one or more metallic materials. For example, the torsion spring 734 may be made of 17-7 hardened stainless steel. The torsion spring 734 may have a wire diameter of 0.207 inches, an outer diameter of 2.0 inches, and an inner diameter of 1.586 inches that is configured to form a snug fit over a rod of a similar diameter. The torsion spring 734 may have a length of 6.3 inches, 15 coils, and a pitch between coils of 0.4 inches. The torsion spring 734 may have different winding directions depending on whether the resilient mount 700 is on the left or right side of the cleated conveyor belt cleaner.

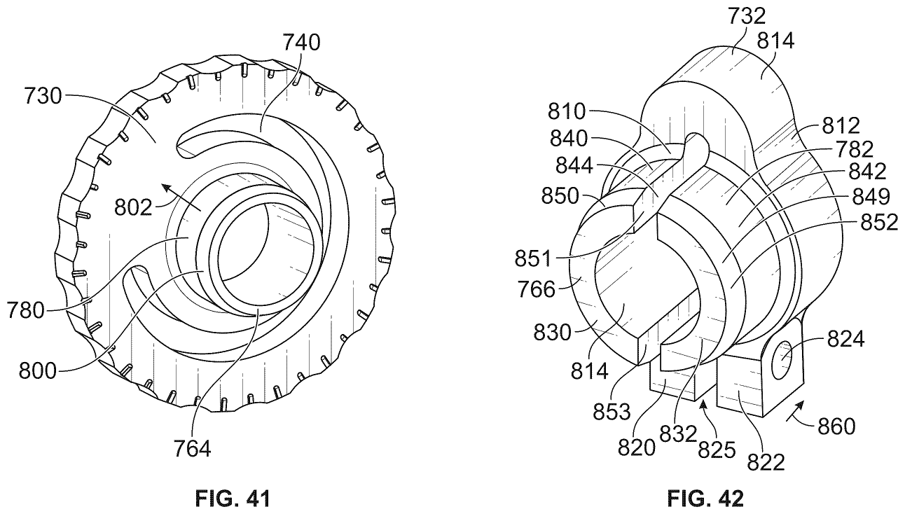

The tensioning hub 730 has a cylindrical boss 764 (see FIG. 41) to receive an end portion 740 of the spring 734 and an adjustment slot 740 that receives a set bolt (e.g., set bolt 175) to fix the tensioning hub 730 at a desired orientation relative to the side plate 706. The split collar 732 has a cylindrical boss 766 (see FIG. 42) to receive an end portion 742 of the spring 734 opposite the end portion 740 and is clamped onto the shaft 718 as discussed below. The spring 734 has coils 735 with an initial inner diameter 752 prior to loading of the spring 734 that is smaller than outer diameters 760, 762 of the bosses 764, 766 of the tensioning hub 730 and the collar 732 to allow the spring end portions 740, 742 to initially grip the bosses 764, 766. As discussed below, relative turning of the tensioning hub 730 and split collar 732 loads or tensions the spring 734 which tightly constricts the spring end portions 740, 742 around the bosses 764, 766. The bosses 764, 766 have tapered lead-in surfaces 800, 849 to radially expand the end portions 740, 742 of the spring 734 as the end portions 740, 742 are positioned on the bosses 764, 766 during assembly of the resilient mount 700.

As the cleaning blade associated with the resilient mount 700 engages and travels around a conveyor belt cleat, the arm 720, shaft 718, and collar 732 turn together in direction 721 while the tensioning hub 730 remains stationary and fixed to the side plate 706. The turning of the collar 732 in direction 721 relative to the tensioning hub 730 resiliently loads the spring 734 and causes the inner diameter 752 of the spring 734 to decrease. The decreasing inner diameter 752 of the spring 734 at the spring end portions 740, 742 constricts the spring end portions 740, 742 around the bosses 764, 766 to form frictional constriction connections 736, 738 between the spring end portions 740, 742 and bosses 764, 766. More specifically, the constriction of the spring end portions 740, 742 around the bosses 764, 766 occurs via end coils 735A, 735B of the coils 735 of the torsion spring 734 whose diameter decrease during loading so that radially inner surface portions 790, 792 of the end coils 735A, 735B firmly engage and tightly grip onto outer annular surfaces 780, 782 of the cylindrical bosses 764, 766. The frictional engagement between the spring radially inner surface portions 790, 792 and boss outer surfaces 780, 782 securely fixes the end coils 735A, 735B of the spring 734 to the bosses 764, 766 of the tensioning hub 730 and collar 732 during operation of the belt cleaner when engaging cleats of the conveyor belt. In this manner, the constriction of coils 735 upon loading of the spring 734 both resiliently absorbs energy from movement of the cleaning blade around a conveyor belt cleat and secures the spring 734 to the tensioning hub 730 and collar 732.

During installation of a cleated conveyor belt cleaner that includes the resilient mount 700, an installer sets the resilient mount 700 to a desired level of preload by first loosening the set bolt that extends in the circumferentially extending adjustment slot 740 of the tensioning hub 730. Next, the installer turns the tensioning hub 730 in direction 723 (see FIG. 39) to bring the cleaning blade into contact with the cleated conveyor belt. With reference to FIG. 40, the outer surfaces 780, 782 of the bosses 764, 766 are sufficiently rough, such as having a textured surface, to provide an initial lower level of gripping engagement of the end coils 735A, 735B onto the bosses 764, 766 as the installer starts to turn the tensioning hub 730 in direction 723.

Once the cleaning blade is engaged with the belt, continued turning of the tensioning hub 730 in direction 723 turns the tensioning hub 730 and spring end portion 740 fixed thereto relative to the collar 732 and spring end portion 742 fixed thereto. The turning of the end portion 740 relative to the end portion 742 loads the spring 734 by decreasing the inner diameter of its coils 735 and causes end coils 735A, 735B of the end portions 740, 742 to constrict around and tightly engage the bosses 764, 766 of the tensioning hub 730 and collar 732. Once the installer has applied a desired preload to the resilient mount 700, the installer tightens down the set bolt extending in the adjustment slot 740 of the tensioning hub 730 to fix the tensioning hub 730 relative to the side plate 706 and maintain the desired preload in the resilient mount 700.

During operation of a cleated conveyor belt, pivoting of the arm 722 and shaft 718 in direction 721 (see FIG. 39) due to the associated cleaning blade engaging and traveling over a conveyor belt cleat further tensions or loads the spring 734 beyond the preload and even more tightly constricts the end coils 735A, 735B around the tension hub 730 and collar 732. The end coils 735A, 735B of the spring end portions 740, 742 thereby more tightly constrict and engage the tensioning hub 730 and collar 732 as the torsion load in the spring 734 increases. The concurrent increasing constriction force of the end coils 735A, 735B with increasing torsion load in the spring 734 permits the end coils 735A, 735B to remain fixed to the tensioning hub 730 and collar 732 even when the spring 734 experiences high torsional loads.

The spring 734 has free coils 749 (see FIG. 40) that are spaced from the tensioning hub 730 and collar 732 and are able to further constrict and develop increasing torque to resiliently resist pivoting of the arm 720 in direction 721 while the end coils 735A, 735B are kept from constricting further by the outer diameters 760, 762 of the bosses 764, 766. The overall length of the spring 734 and/or the pitch of the coils of the spring 734 are selected to provide a desired number of free coils 749 and a desired number of end coils 735A, 735B engaged with the tensioning the hub 730 and collar 732. The number of free coils 749 is selected to permit the spring 734 to resiliently deflect and accommodate a desired amount of angular displacement of the shaft 714 and arm 720, with a greater number of free coils 749 generally permitting a greater amount of angular displacement of the shaft 714 and arm 720. A greater number of free coils 749 may reduce the peak stress experienced by each coil 749 for a given angular displacement of the shaft 714 and arm 720 since each coil 749 elongates less to compensate for the angular displacement of the shaft 714 and arm 720. As another consideration, the pitch of the free coils 749 is selected to provide adequate spacing between the free coils 749 to permit the free coils 749 to constrict and expand as the shaft 714 and arm 720 pivot in directions 721, 725. The pitch of the free coils 749 is also selected to provide adequate spacing between coils to facilitate cleaning of the resilient mount 700.

With reference to FIG. 41, the boss 764 of the tensioning hub 730 includes the tapered lead-in surface 800 that centers and radially expands the spring end portion 740 as the spring end portion 740 is slid in axial direction 802 onto the boss 764 during assembly of the spring 734 and tensioning hub 730. Likewise, as shown in FIG. 42, the boss 766 of the collar 732 has the tapered lead-in surface 849 that centers and radially expands the spring end portion 742 as the spring end portion 742 is slid in axial direction 860 onto the boss 766.

With reference to FIG. 42, the split collar 732 includes two half collar portions 810, 812 joined by an upper arcuate connecting portion 814. There is an opening 814 extending through the collar 732 to receive the shaft 718. The collar 732 has lower tabs 820, 822 with through openings 824 to receive a shank of a bolt with a head positioned against one of the tabs 820, 822 and an associated nut positioned against the other of the tabs 820, 822. Shifting of the nut toward the bolt head, such as by tightening the nut, urges the tabs 820, 822 together, narrows a gap 825 between the tabs 820, 822 to draw the half collar portions 810, 812 toward each other, and clamps the collar 732 onto the shaft 718.

The collar 732 includes a slot 844 that bisects the boss 766 and forms two boss half portions 830, 832. The boss half portions 830, 832 have respective outer surface portions 840, 842 thereon that cooperate to form the outer surface 782 of the boss 766. The boss half portions 830, 832 also have tapered lead-in surface portions 850, 852 that cooperate to form the tapered lead-in surface 849 of the boss 766. Further, the boss half portions 830, 832 have upper and lower gaps 851, 853 therebetween that narrow upon clamping of the collar 732 onto the shaft 718.

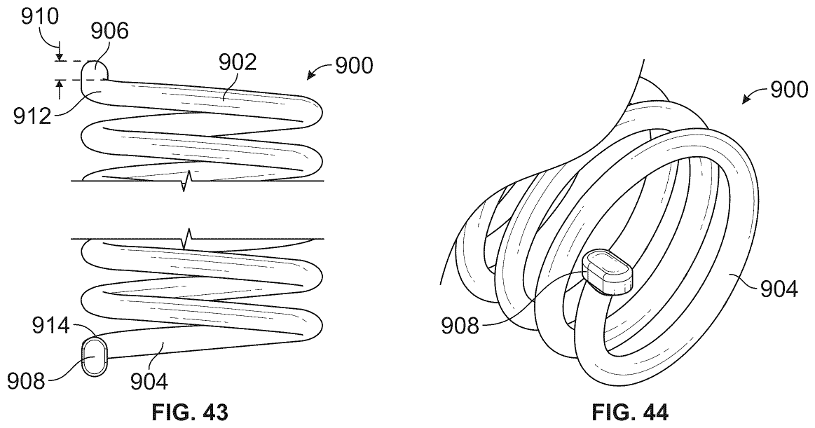

In some embodiments, the spring 734 may include one or more securements to inhibit movement of the end portions 740, 742 of the spring 734 relative to the tensioning hub 730 and collar 732 in addition to relying on the constriction of the end coils 735A, 735B of the spring 734 around the tensioning hub 730 and collar 732 for this purpose. As an example in this regard, a spring 900 is illustrated in FIGS. 43 and 44 that may be used in place of the spring 734 with appropriate cooperating features formed in the tensioning hub 730 and collar 732. More specifically, the spring 900 includes endmost coils 902, 904 with axial protrusions, such as beads 906, 908 that protrude axially by a distance 910 from ends 912, 914 of the end coils 902, 904. The beads 906, 908 may be welded onto the end coils 902, 904, or may be formed by deforming a portion of the end coils 902, 904, as another example.

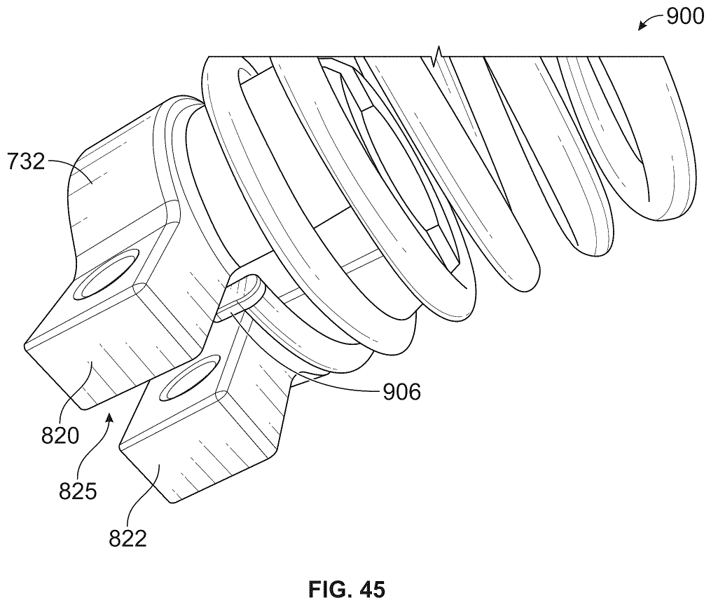

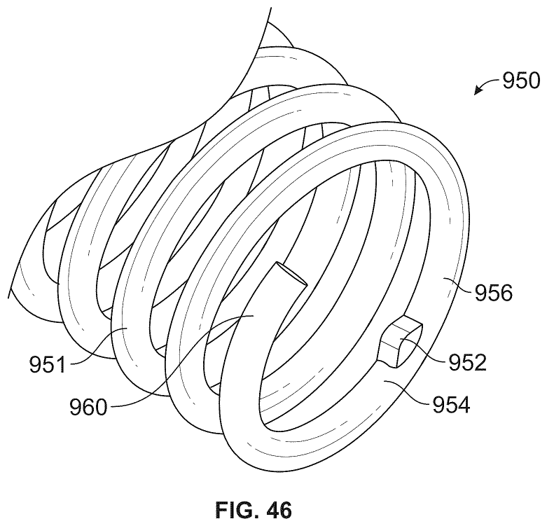

The beads 906, 908 are configured to extend into cooperating openings of the tensioning hub 730 and collar 732. With reference to FIG. 45, the bead 906 is shown extending into the gap 825 between the tabs 820, 822 of the collar 732. The bead 906 is positioned to contact either tab 820, 822 and inhibit turning of the spring 900 relative to the collar 732. The bead 908 would extend into a cooperating opening of the tensioning hub 730 in a similar manner.

With reference to FIG. 46, a spring 950 is provided with another example of a securement to inhibit movement of the spring 950 relative to the tensioning hub 730 and/or collar 732. The securement of the spring 950 operates in conjunction with the constriction of coils 951 of the spring 950 around the tensioning hub 730 or collar 732. More specifically, the spring 950 includes a radial protrusion, such as a bead 952, protruding from a radially inner surface portion 954 of an endmost coil 956 of the spring 950. The opposite endmost coil of the spring 950 may have a similar bead 952. The bead 952 may be positioned along the endmost coil 956 such as at an intermediate position as shown in FIG. 45, or at an end portion 960 of the end coil 956 similar to beads 906, 908. The endmost coils of the spring 950 may each have two or more beads 952 for engaging recesses on the tensioning hub 730 and collar 732.

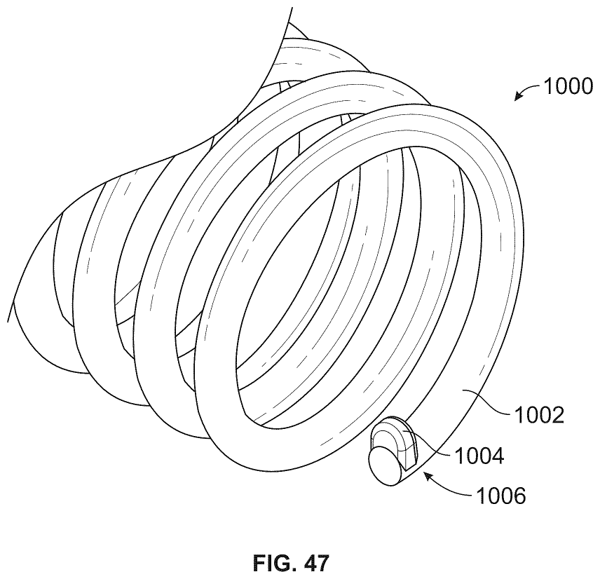

With reference to FIG. 47, a spring 1000 is provided having an end coil 1002 with a radial protrusion, such as a bead 1004, at an end 1006 of the end coil 1002. The bead 1004 is configured to extend into an opening of one of the tensioning hub 730 and the collar 732 to resist turning of the spring 1000 relative to the one of the tensioning hub 730 and the collar 732. The opposite end coil of the spring 1000 may have a similar radial protrusion to extend into an opening of the other of the tensioning hub 730 and collar 732. In one embodiment, the resilient mount 700 is provided with a spring having one end, or both ends, that include radial protrusions similar to protrusion 952 and 1004.

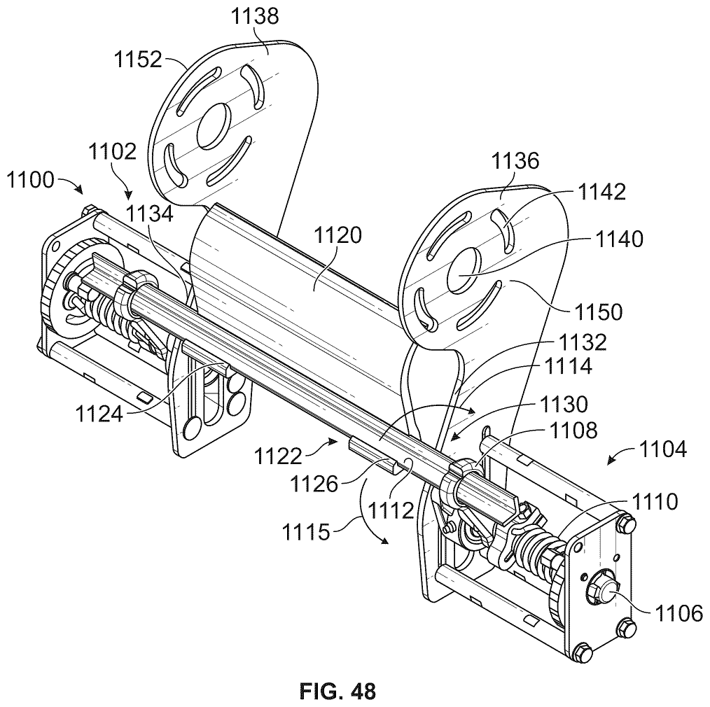

Regarding FIG. 48, a cleated conveyor belt cleaner 1100 is provided that is similar in many respects to the cleated conveyor belt cleaners discussed above. The cleated conveyor belt cleaner 1100 includes resilient mounts 1102, 1104 that each include a shaft 1106 and an arm 1108 secured to the shaft 1106, and a torsion spring 1110 for biasing the arm 1108 and an angle bar 1112 connected thereto in a direction 1114. The cleated conveyor belt cleaner 1100 has a cleaning blade 1120 and a releasable connection 1122 between the cleaning blade 1120 and the angle blade 1112. The releasable connection 1122 includes gripping portions 1124, 1126 that are spaced apart along the angle bar 1112 as discussed in greater detail below.

The cleated conveyor belt cleaner 1100 includes one or more stops 1130 that inhibits the angle bar 1112 from pivoting beyond a predetermined rotary position in direction 1114. In one embodiment, the stops 1130 includes edges 1132, 1134 of brackets, such as mounting plates 1136, 1138, of the resilient mounts 1102, 1104. To replace the cleaning blade 1120, a user stops operation of the associated conveyor belt and manually pivots the angle bar 1112 in direction 1115 to disengage the cleaning blade 1120 from the conveyor belt before disconnecting the cleaning blade 1120 from the angle bar 1112. The user then gradually releases the angle bar 1112 and permits the torsion springs 1110 to pivot the angle bar 1112 in direction 1114 until the angle bar 1112 contacts the mounting plate edges 1132, 1134. The mounting plate edges 1132, 1134 inhibit further pivoting of the angle bar 1112 in direction 1114 and full unloading of the torsion springs 1110. The mounting plate edges 1132, 1134 thereby maintain tension in the torsion springs 1110 and avoids the user having to re-tension the cleated conveyor belt cleaner 1100 every time the cleaning blade 1120 is replaced.

To install a new cleaning blade 1120, the user manually pivots the angle bar 1112 in direction 1115 to provide space between the angle bar 1112 and the conveyor belt for the user to connect the new cleaning blade 1120. Once the new cleaning blade 1120 has been connected to the angle bar 1112, the user gradually releases the angle bar 1112 and permits the torsion springs to pivot the angle bar 1112 in direction 1114 until the new cleaning blade 1120 engages the conveyor belt. The user may then restart operation of the conveyor belt. In this manner, the one or more stops 1130 provide a temporary resting position for the angle bar 1112 when the cleaning blade 1120 is being replaced and maintain tension in the torsion springs 1110. The mounting plates of other embodiments of cleated conveyor belt cleaners discussed herein likewise provide stops for the associated angle bar. For example and with reference to FIG. 11, the cleated conveyor belt cleaner 30 has mounting plates 126, 126A that are arranged to limit pivotal movement of angle bar 36 in direction 420 when the cleaning blade 32 has been removed.

The brackets 1136, 1138 each include opening 1140 to receive a shaft of a head pulley and slots 1142 through which mounting fasteners of a flat bearing that supports the shaft of the head pulley. In this manner, the flat bearings are positioned laterally outward upon surfaces 1150, 1152 such that the brackets 1136, 1138 are each sandwiched between one of the flat bearings and the conveyor structure.

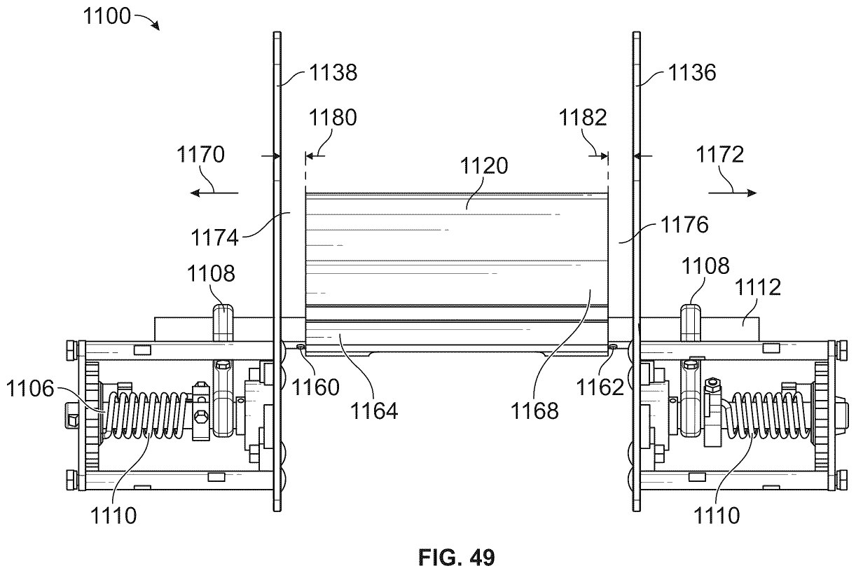

Regarding FIG. 49, the angle bar 1112 has one or more retainers, such as protrusions 1160, 1162, arranged to contact lateral side portions 1164, 1168 of the cleaning blade 1120. The protrusions 1160, 1162 may be positioned on either, or both, of the legs of the angle bar 1112. For example, each leg of the angle bar 1112 may have a pair of protrusions on the angle bar 1112 to provide a total of four points of restraint against lateral movement of the cleaning blade 1120.

The contact between the protrusions 1160, 1162 and lateral side portions 1164, 1168 inhibits lateral shifting of the cleaning blade 1120 in directions 1170, 1172 along the angle bar 1112. In this manner, the protrusions 1160, 1162 keep the cleaning blade 1120 at a predetermined lateral position along the angle bar 1112 so that the cleaning blade 1120 is longitudinally aligned with the conveyor belt and fully engaged therewith. The protrusions 1160, 1162 keep the cleaning blade 1120 at lateral distances 1180, 1182 from the mounting plates 1136, 1138. In one embodiment, the distances 1180, 1182 are equal and the protrusions 1160, 1162 keep the cleaning blade 1120 centered along the angle bar 1112.

Further, the protrusions 1160, 1162 maintain spacings 1174, 1176 between the cleaning blade 1120 and the conveyor structure associated with the mounting plates 1138, 1136. By maintaining the spacings 1174, 1176, the protrusions 1160, 1162 keep the cleaning blade 1120 from striking the conveyor structure and/or mounting plates 1136, 1138 as the cleaning blade 1120 pivots in directions 1114, 1115 during operation of the cleated conveyor belt cleaner 1100.

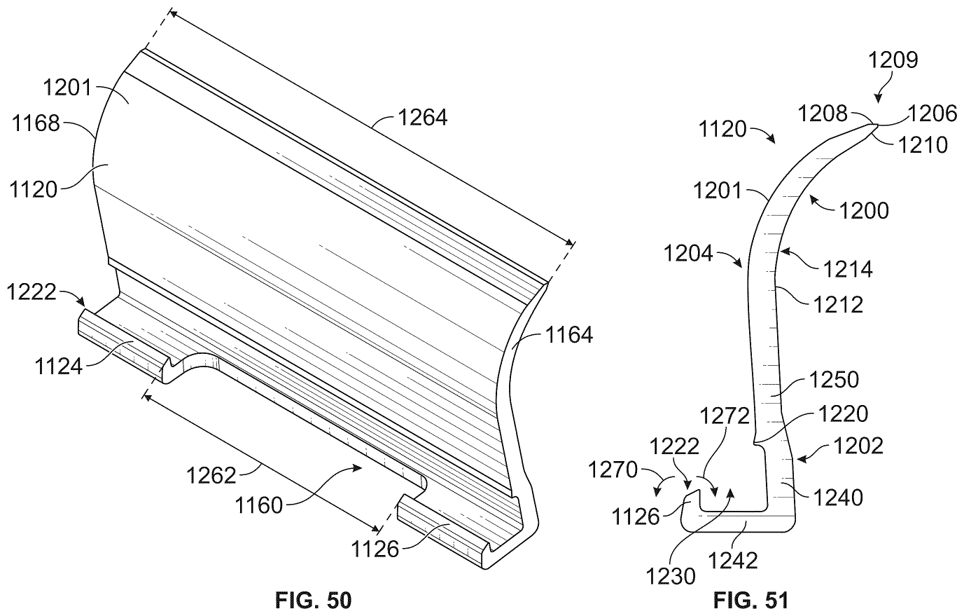

Regarding FIGS. 50 and 51, the cleaning blade 1120 has an upper belt scraping portion 1200, a lower mounting portion 1202, and an intermediate portion 1204. The upper belt scraping portion 1200 has an upper scraping tip 1209 that is similar to the upper scraping tip 90. The upper scraping tip 1209 includes an end surface portion 1206 for engaging the conveyor belt and inclined surface portions 1208, 1210. The intermediate portion 1204 includes a concave surface 1212 forming a recess 1214 for receiving a free end portion of a cleat being scraped by the cleaning blade 1120. The lower mounting portion 1202 has a recess 1230 to receive the angle bar 1112 and front and rear lips 1220, 1222 configured to form a snap-fit engagement with the angle bar 1112. The rear lip 1222 includes the gripping portions 1124, 1126.

The lower mounting portion 1202 includes a front portion 1240, a lower portion 1242, and the gripping portions 1124, 1126 upstanding from the lower portion 1242. The intermediate portion 1204 has a lower intermediate portion 1250 extending upward from the front portion 1240.

Regarding FIG. 50, the gripping portions 1124, 1126 have a lateral spacing 1260 therebetween. The spacing 1260 extends a lateral distance 1262 along a length 1264 of the cleaning blade 1120. The spacing 1260 removes material from the lower mounting portion 1202 to increase the flexibility of the gripping portions 1124, 1126. In this manner, the gripping portions 1124, 1126 may be more easily deflected in directions 1270, 1272 as the user connects the cleaning blade 1120 to, or removes the cleaning blade 1120 from, the angle bar 1112.

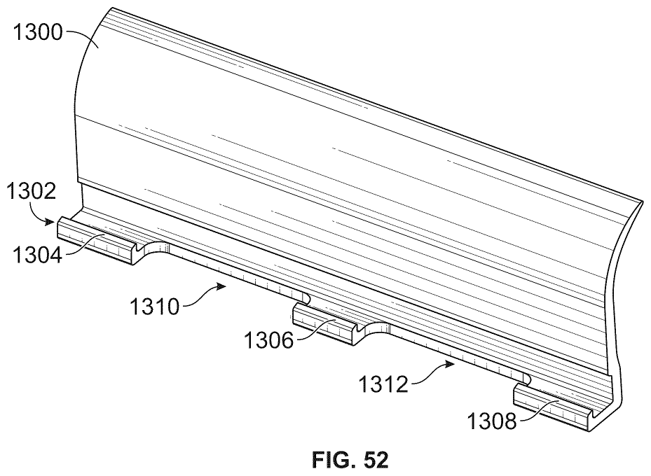

Regarding FIG. 52, a cleaning blade 1300 is provided that is similar in many respects to the cleaning blade 1120. One difference is that the cleaning blade 1300 has a rear lip 1302 with three gripping portions 1304, 1306, 1308 and two spacings 1310, 1312 therebetween. The number of gripping portions and spacings of a particular cleaning blade to be used with the cleated conveyor belt cleaners discussed herein may be selected to provide a desired rigidity of connections as well as ease the removal of the cleaning blade.

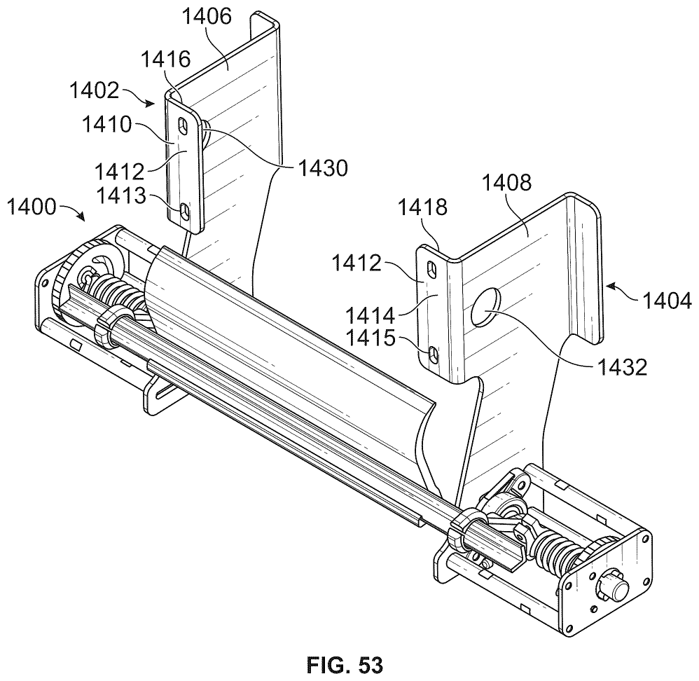

Regarding FIG. 53, a cleated conveyor belt cleaner 1400 is provided that is similar in many respects to the cleated conveyor belt cleaners discussed above. The cleated conveyor belt cleaner 1400 has resilient mounts 1402, 1404 with brackets such as mounting plates 1406, 1408. The mounting plates 1406, 1408 have flanges 1410, 1412 that extend laterally inward, toward one another for being positioned between a conveyor frame and pillow block bearings supporting a head pulley of an associated conveyor belt. Specifically, surfaces 1412, 1414 are for being positioned against the conveyor frame and surfaces 1416, 1418 are for receiving the pillow block bearings. The flanges 1410, 1412 have openings 1413, 1415 for receiving fasteners to secure the pillow block bearings to the conveyor frame. The mounting plates 1406, 1408 have openings 1430, 1432 to receive ends of the head pulley shaft that supported by the pillow block bearings.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

1. A cleated conveyor belt cleaner for cleaning a conveyor belt having a cleat projecting away from a belt portion of the conveyor belt, the cleated conveyor belt cleaner comprising:
a cleaning blade for engaging the conveyor belt;
an elongate support for the cleaning blade;
mounts arranged to orient the elongate support to extend across the conveyor belt and allow the cleaning blade to engage with the conveyor belt and the cleat thereof;
the mounts including a biasing member configured to apply a biasing force to keep the cleaning blade in biased engagement with the cleat as the cleat and the belt portion deflect by permitting the cleaning blade and elongate support to shift away from the belt portion against the bias force during the cleaning blade engagement with the cleat and to bias the elongate support back toward the belt portion and return the cleaning blade into engagement with the conveyor belt after the cleaning blade disengages from the cleat of the conveyor belt.

2. The cleated conveyor belt cleaner of claim 1 wherein the cleaning blade has a belt engaging position wherein the cleaning blade engages the belt portion of the cleated conveyor belt upstream of the cleat and a clearance position wherein the cleaning blade has a spacing from the belt portion with the cleaning blade in biased engagement with the cleat, the spacing being sized to permit the cleat to travel downstream of the cleaning blade; and
wherein the mounts are configured to permit the cleaning blade to be shifted by the cleat against the bias force from the biasing member from the belt engaging position to the clearance position.

3. The cleated conveyor belt cleaner of claim 1 wherein the elongate support is operatively connected to the biasing member and configured to apply a load to the biasing member to increase the biasing force of the biasing member as the cleaning blade engages the cleat and the elongate support shifts away from the belt portion, the biasing member being configured to release the applied load and urge the elongate support back toward the belt portion with the increased bias force in response to disengagement of the cleaning blade from the cleat.

4. The cleated conveyor belt cleaner of claim 1 wherein the mounts are configured to permit the cleaning blade and elongate support to pivot in a first direction away from the conveyor belt as the cleaning blade is in biased engagement with the cleat; and
wherein the biasing member comprises a spring configured to bias the elongate support with the biasing force in an opposite, second direction to return the cleaning blade into engagement with the conveyor belt after the cleaning blade has disengaged from the cleat of the conveyor belt.

5. The cleated conveyor belt cleaner of claim 1 wherein the mounts are configured to permit the elongate support to pivot away from the belt portion about a pivot axis as the cleaning blade is in biased engagement with the cleat of the conveyor belt, the mounts are configured to space the elongate support in a radial direction from the pivot axis, and the cleaning blade extends from the elongate support in a linear direction perpendicular to the radial direction.

6. The cleated conveyor belt cleaner of claim 5 wherein the cleaning blade includes:
a lower intermediate portion for extending from the elongate support in the linear direction perpendicular to the radial direction; and
an upper scraping tip portion extending obliquely to the lower intermediate portion for scraping an upstream surface of the cleat.

7. The cleated conveyor belt cleaner of claim 1 wherein the mounts include first and second pivot shafts that each pivot about a common pivot axis and to which the elongate support is fixed, the first and second pivot shafts have a spacing therebetween along the common pivot axis with the spacing being aligned with the conveyor belt.

8. The cleated conveyor belt cleaner of claim 1 wherein the cleaning blade has a mounting base portion and a free end portion opposite the mounting base portion, the elongate support and the mounts supporting the cleaning blade so that the free end portion extends upstream of the mounting base portion for engaging a base of the cleat, and the cleaning blade has an intermediate portion connecting the free end portion and the mounting base portion, the intermediate portion including a concave area to receive a free end of the cleat as the free end portion of the cleaning blade engages the base of the cleat.

9. The cleated conveyor belt cleaner of claim 1 wherein the cleaning blade has a scraping tip portion with a end surface portion configured to extend across and scrape the conveyor belt in engagement therewith.

10. The cleated conveyor belt cleaner of claim 9 wherein the scraping tip portion includes inclined surface portions and junctures connecting the end surface portion and the inclined surface portions, the inclined surface portions tapering toward each other as the inclined surface portions extend toward the end surface portion.

11. The cleated conveyor belt cleaner of claim 1 wherein the cleaning blade is configured to be releasably connected to the elongate support, the biasing member comprises a pair of springs, and
the resilient mounts include:
a pair of arms supporting the elongate support;
the pair of springs arranged to apply the biasing force to the arms and elongate support; and
a stop configured to limit movement of the arms and elongate support due to the biasing force with the cleaning blade disconnected from the elongate support.

12. The cleated conveyor belt cleaner of claim 1 wherein the mounts include covers movable between a closed position wherein the covers inhibit conveyed objects from becoming caught in the mounts and an open position wherein the covers permit access to the mounts.

13. The cleated conveyor belt cleaner of claim 1 further comprising a dampener arranged to control movement of the cleaning blade as the cleaning blade returns to engagement with the conveyor belt due to the bias force of the biasing member.

14. A cleated conveyor belt cleaner for cleaning a conveyor belt having a belt portion and a cleat projecting therefrom, the cleated conveyor belt cleaner comprising:
a cleaning blade;
an elongate support for the cleaning blade;
a pair of spring tensioners to be installed on opposite sides of the conveyor belt, the spring tensioners being configured to orient the elongate support to extend laterally along a support axis across the conveyor belt and permit pivoting of the elongate support about a pivot axis parallel to and longitudinally offset from the support axis and extending between the spring tensioners, the pivoting of the elongate support being in response to biased engagement of the cleaning blade with the cleat; and
an opening extending longitudinally from the cleaning blade and elongate support to the pivot axis and laterally between the spring tensioners to provide space for an object removed from the conveyor belt to travel through the opening and away from the conveyor belt.

15. The cleated conveyor belt cleaner of claim 14 wherein the cleaning blade has an upstream surface, the cleaning blade being mounted to the elongate support and being configured to orient the upstream surface at an incline to the cleat to permit an object removed from the conveyor belt by the cleaning blade to slide away from the conveyor belt along the upstream surface of the cleaning blade.

16. The cleated conveyor belt cleaner of claim 14 wherein the spring tensioners each include a pivot shaft and an arm interconnecting the elongate support and the pivot shaft, the pivot shafts being spaced apart from one another along the pivot axis.

17. The cleated conveyor belt cleaner of claim 14 wherein the spring tensioners each include a pivot shaft pivotal about the pivot axis, an arm pivotally connecting the elongate support and the pivot shaft, and a torsion spring for biasing the corresponding pivot shaft to pivot about the pivot axis and the cleaning blade into biased engagement with the conveyor belt.

18. The cleated conveyor belt cleaner of claim 17 wherein each torsion spring has a first end portion secured to the pivot shaft and a second end portion secured to a support of the spring tensioner, the first end portion of the torsion spring moving relative to the second end portion with pivoting of the elongate support and pivot shaft about the pivot axis.

19. The cleated conveyor belt cleaner of claim 14 wherein the resilient mounts include mounting plates configured to be secured to conveyor structure to position the pivot axis below and downstream of a head pulley of the conveyor belt; and
wherein the opening extends laterally between the mounting plates of the resilient mounts to permit the removed object to fall through the opening between the mounting plates.

20. A method of cleaning a cleated conveyor belt having a belt portion and a cleat projecting therefrom, the method comprising:
engaging a biased cleaning blade with a leading surface portion of the cleat to scrape the leading surface portion of the cleat;
shifting the cleaning blade against a bias force applied thereto as the cleaning blade engages the leading surface portion of the cleat;
causing the cleat and belt portion to deflect due to the biased engagement of the cleaning blade with the leading surface portion of the cleat at the same time as the cleaning blade is shifting; and
re-engaging the cleaning blade with the belt portion of the cleated conveyor belt downstream of the cleat due to the bias force applied to the cleaning blade after the leading surface portion of the cleat passes beyond the cleaning blade.

21. The method of claim 20 wherein shifting the cleaning blade comprises pivoting the cleaning blade out of a path of the cleat.

22. The method of claim 20 wherein shifting the cleaning blade comprises shifting the cleaning blade away from the belt portion of the cleated conveyor belt.

23. The method of claim 20 wherein shifting the cleaning blade comprises shifting the cleaning blade away from the belt portion of the conveyor belt a distance sized to permit the cleat to travel downstream of the cleaning blade.

24. The method of claim 20 wherein shifting the cleaning blade comprises pivoting the cleaning blade in a first direction, the method further comprising:
disengaging the cleaning blade from the cleat; and
pivoting the cleaning blade in a second direction opposite the first direction to re-engage the cleaning blade with the belt portion downstream of the cleat.

25. The method of claim 20 wherein re-engaging the cleaning blade with the belt portion of the cleated conveyor belt comprises snapping the cleaning blade into engagement with the belt portion of the cleated conveyor belt downstream of the cleat.

26. The method of claim 20 further comprising, before engaging the biased cleaning blade with the leading surface portion of the cleat, engaging the biased cleaning blade with an upstream belt surface of the belt portion upstream of the cleat and engaging the biased cleaning blade with a tapered base surface portion of the cleat that connects the leading surface portion of the cleat and the upstream belt surface.

27. The method of claim 20 wherein engaging the cleaning blade with the leading surface portion of the cleat comprises moving a scraping tip portion of the cleaning blade from a base portion of the cleat to a free end portion of the cleat.

28. The method of claim 20 wherein engaging the biased cleaning blade with the leading surface portion of the cleat comprises applying a load to a biasing member of mounts supporting the cleaning blade.

29. The method of claim 28 wherein re-engaging the scraping blade with the belt portion of the cleated conveyor belt comprises the biasing member releasing the load and returning the scraping blade into engagement with the belt portion of the cleated conveyor belt.

30. The method of claim 20 further comprising scraping an object upstream of the cleat off of the cleated conveyor belt and permitting the object to slide away from the cleated conveyor belt along a surface of the cleaning blade.

31. The method of claim 20 wherein the belt portion comprises a belt segment including the cleat and connected to other belt segments of the belt portion via hinges; and
wherein causing the cleat and belt portion to deflect includes pivoting the belt segment relative to at least one of the other belt segments.

32-44. (canceled)
